(19) United States
(12) Patent Application Publication
(10) Pub. No.: US 2007/0222811 A1
(43) Pub. Date: Sep. 27, 2007

(54) Image recording method and image recording apparatus

(75) Inventor: Terukazu Yanagi, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/727,122

(22) Filed: Mar. 23, 2007

(30) Foreign Application Priority Data
Mar. 27, 2006 (JP) 2006-086465

(51) Int. Cl. B41J 2/015; B41J 2/17

(52) U.S. Cl. 347/21; 347/98; 347/96

(57) ABSTRACT

The image recording method for forming an image on a recording medium, includes the step of applying droplets of stimulus-responsive ink which responds to a stimulus so that the stimulus-responsive ink converts from a sol state to a gel state, on the recording medium, wherein each of the droplets of the stimulus-responsive ink has a volume of 0.5 pl to 2.5 pl.

### BACKGROUND OF THE INVENTION

1. Field of the Invention

The present invention relates to an image recording method and an image recording apparatus used in a printer or printing machine which is capable of high-speed recording and provides an image of high quality.

2. Description of the Related Art

With the rapid progress of inkjet technology and digital cameras and other digital imaging technology in recent years, it has become possible to obtain high-quality photographic prints which surpass silver halide photographs, easily, even in a domestic situation. Moreover, inkjet technology has started to be adapted for and applied to various fields, such as print industry. However, in the field of print industry, it is desirable to achieve high-speed operation, from the viewpoint of productivity, but as yet there is no image recording method which enables high speed printing with high-quality image of the level of a silver halide printing. Therefore, study has been undertaken into various types of recording methods capable of providing high-quality images at high speed. For example, Japanese Patent Application Publication No. 2004-210940 discloses a method in which a stimulus-responsive ink converting from a sol to a gel is used. The stimulus-responsive ink which converts from a sol to a gel in this way is able to reduce the bleeding of the ink.

Although the stimulus-responsive ink which converts from a sol to a gel as described in Japanese Patent Application Publication No. 2004-210940 thus reduces the ink bleeding, the ink droplets convert from a liquid state to a solid state while the ink droplets maintain their droplet shapes. Therefore, the pile height (i.e., the height of ink droplets that lay on the surface of the recording medium) of the solidified (gelatinized) ink droplets is liable to be high, and hence undulations created by the gelatinized ink droplets are liable to be noticeable. Light is reflected randomly because of these undulations created by the ink droplets, especially in cases of a paper (such as art paper serving as a coated paper for printing) on which permeation of the liquid ingredients is slow. Consequently, a new possibility that the image quality degrades due to the large pile height may arise.

### SUMMARY OF THE INVENTION

The present invention has been contrived in view of the foregoing circumstances, an object thereof being to provide an image recording method and an image recording apparatus which not only prevents the ink bleeding in order to obtain an image of high quality at high speed, but also reduces the pile height based on ink that converts from a sol state to a gel state so that image quality degradation is prevented.

In order to attain the aforementioned object, the present invention is directed to an image recording method for forming an image on a recording medium, including the step of applying droplets of stimulus-responsive ink which responds to a stimulus so that the stimulus-responsive ink converts from a sol state to a gel state, on the recording medium, wherein each of the droplets of the stimulus-responsive ink has a volume of 0.5 pl to 2.5 pl.

Preferably, each of the droplets of the stimulus-responsive ink has a volume of 0.5 pl to 1.5 pl.

The inventors carried out keen examination about methods for resolving image degradation caused by the large pile height based on ink that converts from a sol to a gel due to a stimulus, and they have obtained the following knowledge. More specifically, in an image recording method which forms images by depositing ink that converts from a sol to a gel due to a stimulus, onto a recording medium, it is possible to prevent image degradation caused by the large pile height, by setting the volume of a single ink droplet to 0.5 to 2.5 pl.

Here, if the volume of a single ink droplet is less than 0.5 pl, then due to the small size of the liquid droplet, the air resistance is relatively large with respect to the kinetic energy of the ejected droplet, and unless energy, such as electrostatic energy, is applied to the droplet, then it is difficult to deposit the ink droplet accurately on the medium (recording medium). This leads to degradation of the image quality due to decline in the depositing accuracy. Therefore, from the viewpoint of energy saving, it is desirable for the volume of a single ink droplet to be 0.5 pl or above. On the other hand, if the ink droplet size is greater than 2.5 pl, then image quality degradation can be visible because of the large pile height due to undulations created by gelatinized ink droplets (unlike in the case of a permeable ink) since the ink solvent contained in the gelatinized ink also converts from a liquid state to a solid state. Hence, a liquid droplet size of 2.5 pl or less is desirable, and a liquid droplet size of 1.5 pl or less is even more desirable since the pile height is small enough that the image quality degradation can be hardly visible.

Consequently, in the above-mentioned image recording method which forms an image by depositing ink that converts from a sol to a gel due to a stimulus, on a recording medium, it is possible to prevent image degradation caused by the large pile height, by setting the volume of a single ink droplet to not less than 0.5 pl and not greater than 2.5 pl.

Moreover, it is possible to prevent image degradation caused by the large pile height more effectively, by setting the volume of a single ink droplet to not less than 0.5 pl and not greater than 1.5 pl.

Preferably, the image recording method, further comprises the step of applying a treatment liquid on the recording medium, wherein: the treatment liquid comes into contact with the droplets of the stimulus-responsive ink in a droplet ejection region of the recording medium where the droplets of the stimulus-responsive ink are applied; and the stimulus to which the stimulus-responsive ink responds is a chemical stimulus caused by the treatment liquid.

According to this aspect of the present invention, in the droplet ejection region where ink is applied, an image is formed by using a treatment liquid which causes the ink to convert from a sol to a gel due to a chemical stimulus, and therefore, it is possible to convert the ink to a gel state satisfactorily and hence bleeding can be prevented.

Preferably, the chemical stimulus is based on a pH change.

According to this aspect of the present invention, since the ink can be converted to a gel state by means of a pH change, then it is possible to obtain a high-quality image readily, at high speed.

Preferably, the image recording method, further comprises the step of applying a liquid composition which does not contain coloring material and responds to a stimulus caused by the treatment liquid so that the liquid composition converts from a sol state to a gel state, on the recording medium wherein the liquid composition comes into contact with the treatment liquid in a non-droplet ejection region of the recording medium where the droplets of the stimulus-responsive ink are not applied.

According to this aspect of the present invention, since droplets of the liquid which does not contain a coloring material and which converts from a sol to a gel due to a stimulus are applied on the region of the recording medium where the ink droplets are not applied, and since this liquid is converted into a gel in response to the stimulus of the treatment liquid, then it is possible to prevent image degradation in the region on the recording medium where the ink droplets are not applied, in the same way as in the region where the ink droplets are applied. Consequently, a high-quality image which is free of undulations over the whole recording medium can be obtained.

Preferably, the stimulus-responsive ink contains at least a water-insoluble coloring material, a water-soluble organic solvent, a polymer dispersant, and water; and the polymer dispersant contains a block copolymer having at least one type of hydrophobic block and at least one type of hydrophilic block.

According to this aspect of the present invention, by using a block copolymer including a hydrophobic block and a hydrophilic block, as a polymer dispersant, then it is possible to make the hydrophobic block part of the polymer dispersant adhere uniformly to the surfaces of the water-insoluble coloring material, and hence the water-insoluble coloring material is not exposed but rather is covered uniformly with the polymer dispersant, in such a manner that capsules can be formed. Consequently, a capsule state is maintained stably even when ejection for inkjet recording where the dispersion is liable to become unstable is performed, and hence ejection stability is improved. Moreover, since the hydrophilic block of the polymer dispersant forms the hydrophilic part, then it has good affinity with the ink medium and the dispersion stability of the coloring material is greatly improved. Therefore, aggregation or sedimentation of the dispersed coloring material becomes less likely to occur, and ejection stability and storage stability in cases of the long storage can be improved.

Preferably, the liquid composition contains ingredients which are same as all ingredients except for a water-insoluble coloring material contained in the stimulus-responsive ink.

According to this aspect of the present invention, the liquid having all ingredients of the stimulus-responsive ink except for a water-insoluble coloring material is applied on the region of the recording medium where the ink is not applied, in such a manner that the liquid comes into contact with the treatment liquid. Therefore, it is possible to obtain an image of high quality which is free of undulations, in the whole of the image on the recording medium.

Preferably, the water-insoluble coloring material contains at least one material selected from the group consisting of C.I. Solvent Yellow 21, C.I. Solvent Yellow 42, C.I. Solvent Yellow 79, C.I. Solvent Yellow 82, C.I. Solvent Yellow 83:1, C.I. Solvent Yellow 88, and C.I. Solvent Yellow 151.

Preferably, the water-insoluble coloring material contains at least one material selected from the group consisting of C.I. Solvent Red 8, C.I. Solvent Red 49, C.I. Solvent Red 83:1, C.I. Solvent Red 91, C.I. Solvent Red 127 and C.I. Solvent Red 218.

Preferably, the water-insoluble coloring material contains at least one material selected from the group consisting of C.I. Solvent Blue 25, C.I. Solvent Blue 38, C.I. Solvent Blue 44, C.I. Solvent Blue 67, and C.I. Solvent Blue 70.

Preferably, the water-insoluble coloring material contains at least one material selected from the group consisting of C.I. Solvent Black 3, C.I. Solvent Black 27, C.I. Solvent Black 29 and C.I. Solvent Black 45.

Preferably, the water-insoluble coloring material contains at least one material selected from the group consisting of C.I. Pigment Yellow 3, C.I. Pigment Yellow 74, C.I. Pigment Yellow 93, C.I. Pigment Yellow 95, C.I. Pigment Yellow 109, C.I. Pigment Yellow 120, C.I. Pigment Yellow 128, C.I. Pigment Yellow 138, C.I. Pigment Yellow 150, C.I. Pigment Yellow 151, C.I. Pigment Yellow 155, C.I. Pigment Yellow 175, C.I. Pigment Yellow 183, C.I. Pigment Yellow 184, C.I. Pigment Violet 19, C.I. Pigment Violet 23, C.I. Pigment Red 122, C.I. Pigment Red 254, C.I. Pigment Green 36 and C.I. Pigment Blue 15:3.

These aspects of the present invention are effective because the stimulus-responsive ink contains the water-insoluble coloring material of these kinds.

Preferably, the stimulus-responsive ink contains a water-insoluble coloring material having a particle size of not greater than 80 nm.

According to this aspect of the present invention, the water-insoluble coloring material has a particle size of 80 nm or less, and therefore it is preferable in terms of the color reproducibility.

Preferably, the droplets of the stimulus-responsive ink are applied on the recording medium by transferring the droplets of the stimulus-responsive ink from an intermediate body to the recording medium.

This aspect of the present invention is also effective because of an image recording method which transfers a liquid droplet of ink from the intermediate body to the recording medium. Here, desirably, the intermediate body is in the form of a belt or a drum and is made of a material which has heat resistance, durability, and good separability characteristics which enable the ink image to be readily separated.

In order to attain the aforementioned object, the present invention is also directed to an image recording apparatus which forms an image by means of any one of the above-mentioned image recording methods.

This aspect of the present invention relates to an image recording apparatus which implements any one of the above-mentioned image recording methods according to aspects of the present invention.

According to the present invention, it is possible to not only reduce the pile height which is liable to be large in cases of ink that converts from a sol to a gel due to a stimulus, but also prevent ink bleeding. Therefore, high-speed production of high-quality prints can be achieved.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general compositional diagram showing an inkjet recording apparatus forming an image forming apparatus according to an embodiment of the present invention;

FIGS. 2A and 2B are plan view perspective diagrams showing a compositional example of a print head;

FIG. 3 is a plan view perspective diagram showing another compositional example of a full-line type print head;

FIG. 4 is a cross-sectional diagram taken along line 4-4 in FIGS. 2A and 2B;

FIG. 5 is an enlarged diagram showing a nozzle arrangement of the print head shown in FIGS. 2A and 2B;

FIG. 6 is a general compositional diagram showing an ink supply system in the inkjet recording apparatus according to an embodiment of the present invention;

FIG. 7 is a principle block diagram showing system composition of the inkjet recording apparatus according to an embodiment of the present invention; and

FIG. 8 is an illustrative diagram showing a frame format of an image formation process in the inkjet recording apparatus according to an embodiment of the present invention.

### DETAILED DESCRIPTION OF THE PREFERRED EMBODIMENTS

Image degradation caused by the large pile height which is based on ink converting from a sol to a gel in accordance with a stimulus, can be resolved by the following method. Below, an embodiment of the present invention is described in detail.

In an image recording method which forms images on a recording medium by depositing ink that converts from a sol to a gel in accordance with a stimulus, it is possible to avoid image degradation caused by the large pile height, by setting the liquid droplet volume per ink dot in a range from 0.5 pl to 2.5 pl.

If the liquid droplet volume per dot is less than 0.5 pl, then due to the small size of the liquid droplet, the air resistance is relatively large with respect to the kinetic energy of the ejected droplet. Therefore, unless energy, such as electrostatic energy, is applied to the droplet, then it is not possible to deposit droplets accurately on the recording medium, thus leading to degradation of the image quality due to decline in the deposition accuracy. Hence, from the viewpoint of energy saving, it is desirable for the volume of a single liquid droplet to be 0.5 pl or above. On the other hand, if the liquid droplet size is greater than 2.5 pl, then image quality degradation is visible because of the large pile height due to the undulations created by the solidified ink droplets (unlike in the case of a permeable ink), since the ink solvent in a gelatinization ink converts from a liquid state to a solid state. Hence, a liquid droplet size of 2.5 pl or less is preferable, and a liquid droplet size of 1.5 pl or less is more preferable, since this makes image quality degradation due to the undulations created by the ink droplets barely visible. Moreover, since the amplitude of the undulations created by the ink droplets depends on the pile height, then a method of reducing the pile height is effective. For example, it is beneficial to apply a liquid which does not contain coloring material and which converts from a sol to a gel due to a stimulus, on the ink non-droplet ejection region of the recording medium where the ink is not applied, in such a manner that the liquid comes into contact with the treatment liquid on the recording medium and the liquid converts from a sol to a gel.

The stimulus according to an embodiment of the present invention is, for example, a chemical stimulus, a physical stimulus, or the like. The chemical stimulus includes a temperature change, a pH change, and a concentration change of the component in the ink. The physical stimulus includes application of an electromagnetic field. In embodiments of the present invention, it is also possible to combine two or more types of stimuli of these kinds. In carrying out the present embodiment, the chemical stimulus is preferable. In the cases where the stimulus is based on a temperature change, for instance, desirably, the temperature changes within the range including the phase transition temperature of the ink component. In the cases where the stimulus is based on a pH change in the component, desirably, the pH falls within the range from 3 to 12 during the pH change. In cases where the stimulus is based on a concentration change of the component, desirably, the concentration of the component changes within the range including the critical concentration at which the phase of the component changes. In cases where the stimulus is based on exposure to electromagnetic waves, the electromagnetic waves preferably has a wavelength from 100 nm to 800 nm (e.g. ultraviolet light, visible light, infrared light).

### Treatment Liquid which Converts the Ink from a Sol to a Gel by Means of Chemical Stimulus

The treatment liquid in the present embodiment is used, for example, for the purpose of enabling high-speed printing and suppressing the ink bleeding by converting the ink from a sol to a gel.

There are no particular limitations on the treatment liquid used in the present embodiment, provided that the ink is converted from a sol to a gel by means of the chemical stimulus. Concrete embodiments of the treatment liquid include: a treatment liquid which causes the ink to convert to a gel by changing the pH of the ink; a treatment liquid which causes the ink to convert to a gel by adding an inorganic salt to the ink; a treatment liquid which causes the ink to convert to a gel by adding a compound having a charge opposite to the charge of the coloring material in the ink and causing a reaction between anions and cations; and a treatment liquid which causes the ink to convert to a gel by changing the composition of the solvent in the ink.

In carrying out the present embodiment, the preferred embodiment of the treatment liquid is a treatment liquid which causes the ink to convert to a gel by changing the pH of the ink. More preferably, it is a treatment liquid which converts the ink to a gel by reducing the pH. In this case, preferably, the pH of the treatment liquid is 1 to 6, and more preferably, the pH is 2 to 5, and even more preferably, the pH is 3 to 5. Moreover, in order to make the treatment liquid acidic (in order to reduce the pH of the treatment liquid), the treatment liquid may contain a compound having a structure of furan, pyrrole, pyrroline, pyrrolidone, pyrone, thiophene, indole, pyridine or quinoline, and also having a carboxyl group as a functional group, or the like, for example, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or derivatives of these compounds, salts of these, or the like.

Preferably, the compound for controlling the pH of the ink is pyrrolidone carboxylic acid, pyrone carboxylic acid, furan carboxylic acid, coumaric acid, or derivatives of these compounds, or salts of these. One of these compounds may be used alone, or two or more of these compounds may be used in combination.

Furthermore, instead of the compounds described above, it is also possible to add an inorganic salt to the treatment liquid. The inorganic salt is the reaction product when a metal displaces the hydrogen of an acid. The metal which displaces the hydrogen of an acid includes: an alkali metal, such as lithium, sodium or potassium; and a polyvalent metal, such as aluminum, barium, calcium, copper, iron, magnesium, manganese, nickel, tin, titanium, zinc, or the like. The acid of which hydrogen is displaced by the metal component includes: hydrochloric acid, hydrobromic acid, hydroiodic acid, sulfuric acid, nitric acid, phosphoric acid, thiocyanic acid, or an organic carboxylic acid, such as acetic acid, oxalic acid, lactic acid, fumaric acid, citric acid, salicylic acid benzoic acid or the like, or an organic sulfonic acid.

Moreover, the treatment liquid may contain another additive, provided that it does not impede the beneficial effects of the present invention. The other additive may be, for example, a commonly known additive, such as an anti-drying agent (moisturizing agent), an anti-fading agent, an emulsion stabilizer, a permeation promoter, an ultraviolet absorber, an antiseptic agent, an antibacterial agent, a pH adjuster, a surface tension adjuster, an antifoaming agent, a viscosity adjuster, a dispersant, a dispersion stabilizer, an anti-rusting agent, a chelating agent, a fixing agent (polymer compound, polymer micro-particles), or the like.

### Ink

The ink may be composed in any fashion provided that it is a liquid composition containing a coloring material. Preferably, it contains at least a coloring material (more preferably, the water-insoluble coloring material that is not soluble in water), a water-soluble organic solvent, a gelling agent, and water. In this case, the gelling agent may have any composition, provided that it is capable of converting the ink from a sol into a gel in accordance with a stimulus, and preferably, the gelling agent is a polymer dispersant which is a block copolymer including at least one type of hydrophobic block and at least one type of hydrophilic block.

### Polymer Dispersant

For the polymer dispersant used in the ink according to the present invention, it is possible to use a block copolymer including at least one type of hydrophilic block and at least one type of hydrophobic block, and it is also possible to use a block copolymer having two or more types of hydrophilic block and two or more types of hydrophobic block. Moreover, it is possible to use a single block copolymer or to use a combination of two or more types of block copolymer. The structure of the copolymer includes a straight chain structure and a grafted structure, and the like, and the straight-chain block copolymer is preferable.

Preferably, the polymer dispersant has a polyvinyl ether structure created by polymerizing a vinyl ether monomer, in order to a stable dispersion of the coloring material. More specifically, from the viewpoint of further enhancing the stability of the dispersion of the coloring material in the ink solvent, the polymer dispersant preferably has a hydrophilic block of an anionic polyvinyl ether or a nonionic polyvinyl ether, or a diblock constituted by a nonionic polyvinyl ether block and an anionic polyvinyl ether block. In cases where the hydrophilic block of the polymer dispersant is a diblock polymer constituted by a nonionic polyvinyl ether block and an anionic polyvinyl ether block, in order to further enhance the stability of the dispersion of coloring material in the ink medium, it is more preferable that the diblock polymer is the block copolymer constituted by a polyvinyl ether block having hydrophobic properties, a nonionic polyvinyl ether block having hydrophilic properties, and an anionic polyvinyl ether block having hydrophilic properties, arranged in this order.

Desirably, the vinyl ether block having hydrophobic properties which forms the polymer dispersant is a block having a unit structure as represented by the following general formula:

—(CH₂—CH(OR¹))— (1).

In the general formula (1) described above, R¹ is an aliphatic hydrocarbon group, such as an alkyl group, an alkenyl group, a cycloalkyl group or a cycloalkenyl group, or an aromatic hydrocarbon group, in which carbon atoms may be substituted with nitrogen atoms, such as a phenyl group, a pyridil group, a benzyl group, a tolyl group, a xylyl group, an alkylphenyl group, a phenylalkylene group, a biphenyl group, a phenylpyridyl group, or the like. Furthermore, the hydrogen atom on the aromatic ring may be substituted with a hydrocarbon group. Desirably, R¹ has 1 to 18 carbon atoms.

Furthermore, R¹ may be a group represented by —(CH(R²)—CH(R³)—O)ₚ—R₄ or —(CH₂)ₘ—(O)ₙ—R₄. In this case, R² and R³ represent a hydrogen atom or a methyl group. R⁴ represents an aliphatic hydrocarbon group, such as an alkyl group, an alkylene group, a cycloalkyl group or a cycloalkenyl group, or an aromatic hydrocarbon group, in which carbon atoms may be substituted with nitrogen atoms, such as a phenyl group, a pyridil group, a benzyl group, a tolyl group, a xylyl group, an alkylphenyl group, a phenylalkylene group, a biphenyl group, a phenylpyridyl group, or the like (where the hydrogen atom on the aromatic ring may be substituted with a hydrocarbon group), or —CO—CH═CH₂, —CO—C(CH₃)═CH₂, —CH₂—CH═CH₂, —CH₂—C(CH₃)═CH₂, or the like. In this case, the hydrogen atoms in these groups may be substituted with halogen atoms, such as fluorine, chlorine or bromine, to the extent that it is chemically feasible. Desirably, R⁴ has 1 to 18 carbon atoms, p is 1 to 18, m is 1 to 36, and n is 0 or 1.

The alkyl group and the alkenyl group for R¹ or R⁴ includes methyl, ethyl, propyl, isopropyl, n-butyl, sec-butyl, tert-butyl, pentyl, hexyl, heptyl, octyl, nonyl, decyl, dodecyl, tetradecyl, hexadecyl, octadecyl, oleyl, or the like. The cycloalkyl group and the cycloalkenyl group for R¹ or R⁴ includes cyclopropyl, cyclobutyl, cyclopentyl, cyclohexyl, cyclooctyl, or the like.

Next, one of preferred embodiment of the vinyl ether block having hydrophilic properties is a block having a unit structure as expressed by the following general formula:

—(CH₂—CH(OR⁵))— (2).

In the general formula (2) described above, R⁵ is a group represented by —(CH₂—CH₂—O)ₖ—R⁶, —(CH₂)ₘ—(O)ₙ—R⁶, —R⁷—X, —(CH₂—CH₂—O)ₖ—R⁷—X, —(CH₂)ₘ—(O)ₙ—X. In this case, R⁶ represents a hydrogen atom, a straight-chain or branched alkyl group having 1 to 4 carbon atoms, or —CO—CH═CH₂, —CO—C(CH₃)═CH₂, —CH₂—CH═CH₂, —CH₂—C(CH₃)═CH₂, or the like; R⁷ represents an aliphatic hydrocarbon group, such as an alkylene group, an alkenylene group, a cycloalkylene group or a cycloalkenylene group, or an aromatic hydrocarbon group, in which carbon atoms may be substituted with nitrogen atoms, such as a phenylene group, a pyridilene group, a benzylene group, a tolylene group, a xylylene group, an alkylphenylene group, a phenylene alkylene group, a biphenylene group, a phenyl pyridylene group, or the like (where the hydrogen atom on the aromatic ring may be substituted with a hydrocarbon group), and the hydrogen atoms in these groups may be substituted with halogen atoms, such as fluorine, chlorine or bromine, to the extent that it is chemically feasible. X represents a group having anionic properties, and the group is selected from a carboxylic acid group, a sulfonic acid group, or a phosphoric acid group. Desirably, R⁷ has 1 to 18 carbon atoms, k is 1 to 18, m is 1 to 36, and n is 0 or 1.

In the present invention, the polymer dispersant preferably has pH stimulus-responsive properties in which the association of the polymer dispersant readily occurs when the pH of the ink is reduced. A preferred embodiment is one where the dispersant contains a pH buffering agent having a buffering action in the pH range from (the critical pH+0.1) to (the critical pH+3.0). In this case, the critical pH is the pH at which the polymer dispersant described above displays pH stimulus responsive properties.

The pH stimulus responsive properties of the polymer dispersant contained in the stimulus-responsive ink are properties which cause the polymer chains of the polymer dispersant to associate with each other when the pH of the ink is reduced, thereby increasing the viscosity of the ink. The pH stimulus responsive properties are adjusted by molecular design in such a manner that the ink viscosity after the pH stimulus response is increased to desirably 50 times or more, and more desirably, 100 times or more, the ink viscosity before the pH stimulus response, and thereby good fixing characteristics are obtained in the printed image.

For the polymer dispersant contained in the stimulus-responsive ink, it is possible to use a block copolymer obtained by polymerizing a vinyl ether monomer including at least one type of hydrophobic block and at least one type of hydrophilic block, and it is also possible to use a block copolymer having two or more types of hydrophilic block and two or more types of hydrophobic block. Moreover, it is possible to use a single block copolymer or to use a combination of two or more types of block copolymer. The embodiments of the structure of the copolymer include a straight chain structure, and a grafted structure, and the like, and a straight-chain block copolymer is preferable.

Preferably, the hydrophilic block of the polymer dispersant is constituted by an anionic vinyl ether or nonionic vinyl ether. Alternatively, in order to further enhance the stability of the dispersion of coloring material in the ink solvent, it is desirable to use a diblock polymer including two blocks each of which is constituted by an anionic vinyl ether and a block constituted by nonionic vinyl ether.

In cases where the hydrophilic block of the polymer dispersant is a diblock polymer as described above, in order to further enhance the stability of the dispersion of coloring material in the ink solvent, it is more desirable that the diblock polymer is the block copolymer constituted by a polyvinyl ether block having hydrophobic properties, a nonionic polyvinyl ether block having hydrophilic properties, and an anionic polyvinyl ether block having hydrophilic properties, arranged in this order. Furthermore, a low-molecular dispersant can also be used in combination with the polymer dispersant.

### Low-Molecular Dispersant

The “low-molecular dispersant” indicates a dispersant having a molecular weight of 2000 or less, and desirably, a molecular weight of 100 to 2000, and more desirably, 200 to 2000. The low-molecular dispersant has a structure including a hydrophobic part and a hydrophilic part, and the hydrophilic part is anionic, cationic or nonionic, or has a betaine type combining these.

The low-molecular dispersant may include a plurality of hydrophilic parts and hydrophobic parts, and may include a plurality of different types of hydrophilic parts and hydrophobic parts, provided that the dispersant includes one hydrophilic part and one hydrophobic part in each molecule. Moreover, as appropriate, it is also possible to have a linking group in order to link the hydrophilic and hydrophobic parts.

The anionic group may be any group having a negative electric charge, and desirably, it is a phosphoric acid group, a phosphonic acid group, a phosphinic acid group, a sulfuric acid group, a sulfonic acid, a sulfinic acid or a carboxylic acid group. More desirably, the anionic group is a phosphoric acid group or a carboxylic acid group, and even more desirably, the anionic group is a carboxylic acid group. The cationic group may be any group having a positive electric charge, and desirably, it is an organic cationic substitution group, and more desirably, it is a cationic group containing nitrogen or phosphorus. Even more desirably, it contains pyridinium cations or ammonium cations.

The nonionic group may be polyethylene oxide, or polyglycerine, or a portion of a sugar unit, or the like.

Preferably, the hydrophilic group is an anionic group such as a phosphoric acid group, a phosphonic acid group, a phosphinic acid group, a sulfuric acid group, a sulfonic acid group, a sulfinic acid group or a carboxylic acid group. More preferably, the hydrophilic group is a phosphoric acid group or a carboxylic group, and even more preferably, the hydrophilic group is a carboxylic acid group.

In cases where the dispersant includes an anionic hydrophilic group, from the viewpoint of reactivity with the acidic treatment liquid, it is desirable that the pKa value should be 3 or above. If the pKa of the dispersant is 3 or above, then theoretically, 50% or more of the anionic group assumes a non-dissociative state when it comes into contact with treatment liquid having a pH of approximately 3, and the water solubility declines dramatically, giving rise to an aggregation reaction. In other words, the aggregation reactivity increases. From this viewpoint, desirably, the dispersant includes a carboxylic acid group.

The hydrophobic part may have a hydrocarbon structure, a fluorocarbon structure, or a silicone structure, and a hydrocarbon structure is desirable, and this may be a straight-chain or a branched structure. Moreover, the hydrophobic part may also have a double bond or a triple bond. Furthermore, the hydrophobic part may have one or more than one chain, and if there are two or more chains, then it may have different types of hydrophobic parts. Desirably, the hydrophobic part has a hydrocarbon structure, and more desirably, it is a hydrocarbon having 2 to 24 carbon atoms, even more desirably, a hydrocarbon having 4 to 24 carbon atoms, and particularly desirably, a hydrocarbon having 6 to 20 carbon atoms.

A desirable addition volume for the low-molecular dispersant is 0.01 to 100 wt % with respect to the pigment, more desirably, 0.01 to 50 wt %, and even more desirably, 0.1 to 20 wt %.

### Water-Insoluble Coloring Material

The inks described above can be used in order to form full-color images. In order to form a full-color image, it is possible to use a magenta-toned ink, a cyan-toned ink, and a yellow-toned ink, and a black-toned ink may also be used in order to adjust the color tones. Furthermore, besides the yellow, magenta and cyan-toned inks, it is also possible to use red, green, blue or white inks, or so-called special colored inks used in the field of printing.

For the water-insoluble coloring material contained in the ink used to carry out the present invention, it is possible to use any coloring material which hardly dissolves into water. More specifically, it is desirable that the coloring material should have a solubility with respect to water of 0.5 wt % or less, and more desirably, 0.1 wt % or less. The coloring material may be an oil-soluble dye, a vat dye, a disperse dye, a pigment, or the like, and of these, an oil-soluble dye is desirable in order to create a stable dispersion state of coloring material using the polymer dispersant.

Embodiments of water-insoluble coloring materials are shown below, but the present invention is not limited to these.

### Oil-Soluble Dyes

Possible embodiment of the oil-soluble dye includes: C.I. Solvent Yellow 1, 2, 3, 13, 14, 19, 21, 22, 29, 36, 37, 38, 39, 40, 42, 43, 44, 45, 47, 62, 63, 71, 76, 79, 81, 82, 83, 85, 86, 88, 151; C.I. Solvent Red, 8, 27, 35, 36, 37, 38, 39, 40, 49, 58, 60, 65, 69, 81, 83:1, 86, 89, 91, 92, 97, 99, 100, 109, 118, 119, 122, 127, 218; C.I. Solvent Blue 14, 24, 25, 26, 34, 37, 38, 39, 42, 43, 44, 45, 48, 52, 53, 55, 59, 67, 70; C.I. Solvent Black 3, 5, 7, 8, 14, 17, 19, 20, 22, 24, 26, 27, 28, 29, 43, 45; and the like.

It is possible to cite, as particularly preferred examples of a yellow oil-soluble dye: C.I. Solvent Yellow 21, C.I. Solvent Yellow 42, C.I. Solvent Yellow 79, C.I. Solvent Yellow 82, C.I. Solvent Yellow 83:1, C.I. Solvent Yellow 88, and C.I. Solvent Yellow 151.

It is possible to cite, as particularly preferred examples of a magenta oil-soluble dye: C.I. Solvent Red 8, C.I. Solvent Red 49, C.I. Solvent Red 83:1, C.I. Solvent Red 91, C.I. Solvent Red 127, and C.I. Solvent Red 218.

It is possible to cite, as particularly desirable examples of a cyan oil-soluble dye: C.I. Solvent Blue 25, C.I. Solvent Blue 38, C.I. Solvent Blue 44, C.I. Solvent Blue 67, and C.I. Solvent Blue 70.

Furthermore, it is possible to cite, as particularly desirable examples of a black oil-soluble dye: C.I. Solvent Black 3, C.I. Solvent Black 27, C.I. Solvent Black 29, and C.I. Solvent Black 45.

### Cases where the Water-Insoluble Coloring Material Creates an Ion Complex of an Anionic Dye and a Cationic Surface Active Agent

The anionic dye is a dye having an acid group, such as a sulfonic acid group or a carboxylic acid group, in the molecular frame of the coloring material, and the anionic dye is capable of forming an ion complex through an ionic reaction with a cationic surface active agent. It is desirable that at least one type of dye is selected from a group including direct dyes, acidic dyes, reactive dyes, and food dyes, since such dyes are capable of readily creating an ion complex with the cationic surface active agent.

Possible examples of an anionic dye includes: direct dyes, such as C.I. Direct Black 17, 19, 22, 32, 38, 51, 62, 71, 108, 146, 154; C.I. Direct Yellow 12, 24, 26, 44, 86, 87, 98, 100, 130, 142; C.I. Direct Red 1, 4, 13, 17, 23, 28, 31, 62, 79, 81, 83, 89, 227, 240, 242, 243; C.I. Direct Blue 6, 22, 25, 71, 78, 86, 90, 106, 199; C.I. Direct Orange 34, 39, 44, 46, 60; C.I. Direct Violet 47, 48; C.I. Direct Brown 109; C.I. Direct Green 59, and the like; acidic dyes, such as C.I. Acid Black 2, 7, 24, 26, 31, 52, 63, 112, 118, 168, 172, 208; C.I. Acid Yellow 11, 17, 23, 25, 29, 42, 49, 61, 71; C.I. Acid Red 1, 6, 8, 32, 37, 51, 52, 80, 85, 87, 92, 94, 115, 180, 254, 256, 289, 315, 317; C.I. Acid Blue 9, 22, 40, 59, 93, 102, 104, 113, 117, 120, 167, 229, 234, 254; C.I. Acid Orange 7, 19; C.I. Acid Violet 49, and the like; reactive dyes, such as C.I. Reactive Black 1, 5, 8, 13, 14, 23, 31, 34, 39; C.I. Reactive Yellow 2, 3, 13, 15, 17, 18, 23, 24, 37, 42, 57, 58, 64, 75, 76, 77, 79, 81, 84, 85, 87, 88, 91, 92, 93, 95, 102, 111, 115, 116, 130, 131, 132, 133, 135, 137, 139, 140, 142, 143, 144, 145, 146, 147, 148, 151, 162, 163; C.I. Reactive Red 3, 13, 16, 21, 22, 23, 24, 29, 31, 33, 35, 45, 49, 55, 63, 85, 106, 109, 111, 112, 113, 114, 118, 126, 128, 130, 131, 141, 151, 170, 171, 174, 176, 177, 183, 184, 186, 187, 188, 190, 193, 194, 195, 196, 200, 201, 202, 204, 206, 218, 221; C.I. Reactive Blue 2, 3, 5, 8, 10, 13, 14, 15, 18, 19, 21, 25, 27, 28, 38, 39, 40, 41, 49, 52, 63, 71, 72, 74, 75, 77, 78, 79, 89, 100, 101, 104, 105, 119, 122, 147, 158, 160, 162, 166, 169, 170, 171, 172, 173, 174, 176, 179, 184, 190, 191, 194, 195, 198, 204, 211, 216, 217; C.I. Reactive Orange 5, 7, 11, 12, 13, 15, 16, 35, 45, 46, 56, 62, 70, 72, 74, 82, 84, 87, 91, 92, 93, 95, 97, 99; C.I. Reactive Violet 1, 4, 5, 6, 22, 24, 33, 36, 38; C.I. Reactive Green 5, 8, 12, 15, 19, 23; C.I. Reactive Brown 2, 7, 8, 9, 11, 16, 17, 18, 21, 24, 26, 31, 32, 33, and the like; and food dyes, such as C.I. Food Black 1, 2; C.I. Food Yellow 3; C.I. Food Red 87, 92, 94, and the like.

As a cationic surface active agent, it is possible to use a cationic compound such as a primary, secondary or tertiary amine salt, or quaternary ammonium salt, having a hydrophobic group. In order to further enhance affinity with the hydrophobic block of the polymer dispersant, it is desirable to use a quaternary ammonium salt containing a straight-chain alkyl group having 10 or more carbon atoms, and even more desirably, a straight-chain alkyl group having 12 to 18 carbon atoms.

Possible examples of the cationic surface active agent include: chlorides or bromides, such as decyl trimethyl ammonium, dodecyl trimethyl ammonium, tetradecyl trimethyl ammonium, hexadecyl trimethyl ammonium, octadecyl trimethyl ammonium, didodecyl dimethyl ammonium, dimethyl dietetradecyl ammonium, dimethyl dioctadecyl ammonium, dimethyl dipalmithyl ammonium, dodecyl dimethyl benzyl ammonium, benzalkonium, or the like. The volume of the cationic surface active agent contained in the ink is, desirably, 0.5 to 5.0 times and more desirably, 1.0 to 3.0 times, by mol ratio, with respect to the anionic dye described above.

### Vat Dyes

Possible vat dyes are, for example: C.I. Vat Yellow 2, 4, 10, 20, 33; C.I. Vat Orange 1, 2, 3, 5, 7, 9, 13, 15; C.I. Vat Red 1, 2, 10, 13, 15, 16, 61; C.I. Vat Blue 1, 3, 4, 5, 6, 8, 12, 14, 18, 19, 20, 29, 35, 41; C.I. Vat Black 1, 8, 9, 13, 14, 20, 25, 27, 29, 36, 56, 57, 59, 60; and the like.

### Disperse Dyes

Possible disperse dyes are, for example: C.I. Disperse Yellow 5, 42, 83, 93, 99, 198, 224; C.I. Disperse Orange 29, 49, 73; C.I. Disperse Red 92, 126, 145, 152, 159, 177, 181, 206, 283; C.I. Disperse Blue 60, 87, 128, 154, 201, 214, 224, 257, 287, 368; and the like.

### Pigments

One preferable embodiment of the pigment is a self-dispersion type of pigment. The self-dispersion type of pigment may be an organic pigment or an inorganic pigment. Desirably, the color tones of the pigments used in the ink are black pigment, and three primary color pigments of cyan, magenta and yellow. It is also possible to use color pigments other than those described above, or colorless or light colored pigments, metallic luster pigments, or the like. Furthermore, it is also possible to use a pigment that is newly synthesized for the purpose of the present invention.

Examples of commercially available pigments for black, cyan, magenta and yellow are given below.

Possible examples of the black pigment are: Raven 760 Ultra, Raven 1060 Ultra, Raven 1080, Raven 1100 Ultra, Raven 1170, Raven 1200, Raven 1250, Raven 1255, Raven 1500, Raven 2000, Raven 2500 Ultra, Raven 3500, Raven 5250, Raven 5750, Raven 7000, Raven 5000 Ultra II, Raven 1190 Ultra II (each manufactured by Columbian Carbon Company); Black Pearls L, MOGUL-L, Regal 400R, Regal 660R, Regal 330R, Monarch 800, Monarch 880, Monarch 900, Monarch 1000, Monarch 1300, Monarch 1400 (each manufactured by Cabot Corp.); Color Black FW1, Color Black FW2, Color Black FW200, Color Black 18, Color Black S160, Color Black S170, Special Black 4, Special Black 4A, Special Black 6, Special Black 550, Printex 35, Printex 45, Printex 55, Printex 85, Printex 95, Printex U, Printex 140U, Printex V, Printex 140V (each manufactured by Degussa); No. 25, No. 33, No. 40, No. 45, No. 47, No. 52, No. 900, No. 970, No. 2200B, No. 2300, No. 2400B, MCF-88, MA600, MA77, MA8, MA100, MA230, MA220 (each manufactured by Mitsubishi Chemical Corp.); and the like. The black pigment in the present invention is not limited to these.

Possible examples of a cyan color pigment are: C.I. Pigment Blue-1, C.I. Pigment Blue-2, C.I. Pigment Blue-3, C.I. Pigment Blue-15, C.I. Pigment Blue-15:2, C.I. Pigment Blue-15:3, C.I. Pigment Blue-15:4, C.I. Pigment Blue-16, C.I. Pigment Blue-22, C.I. Pigment Blue-60, or the siloxane cross-linking aluminum phthalocyanine disclosed in U.S. Pat. No. 4,311,775, or the like, but the cyan pigment is not limited to these. Of these, a desirable embodiment of the cyan color pigment is C.I. Pigment Blue 15:3.

Possible examples of a magenta color pigment are: C.I. Pigment Red-5, C.I. Pigment Red-7, C.I. Pigment Red-12, C.I. Pigment Red-48, C.I. Pigment Red-48:1, C.I. Pigment Red-57, C.I. Pigment Red-112, C.I. Pigment Red-122, C.I. Pigment Red-123, C.I. Pigment Red-146, C.I. Pigment Red-168, C.I. Pigment Red-184, C.I. Pigment Red-202, C.I. Pigment Red-207, C.I. Pigment Red-254, and the like, but the magenta pigment is not limited to these.

Of these, desirable embodiments of the magenta color pigment are C.I. Pigment Red 122 and C.I. Pigment Red 254.

Possible examples of a yellow color pigment are: C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-74, C.I. Pigment Yellow-83, C.I. Pigment Yellow-93, C.I. Pigment Yellow-95, C.I. Pigment Yellow-97, C.I. Pigment Yellow-98, C.I. Pigment Yellow-109, C.I. Pigment Yellow-114, C.I. Pigment Yellow-120, C.I. Pigment Yellow-128, C.I. Pigment Yellow-129, C.I. Pigment Yellow-138, C.I. Pigment Yellow-151, C.I. Pigment Yellow-154, C.I. Pigment Yellow-155, C.I. Pigment Yellow-175, C.I. Pigment Yellow-183, C.I. Pigment Yellow-184, and the like, but the yellow pigment is not limited to these.

Of the above mentioned pigments, desirable embodiments of the yellow color pigment are: C.I. Pigment Yellow 3, C.I. Pigment Yellow 74, C.I. Pigment Yellow 93, C.I. Pigment Yellow 95, C.I. Pigment Yellow 109, C.I. Pigment Yellow 120, C.I. Pigment Yellow 128, C.I. Pigment Yellow 138, C.I. Pigment Yellow 150, C.I. Pigment Yellow 151, C.I. Pigment Yellow 175, C.I. Pigment Yellow 183 and C.I. Pigment Yellow 184.

Apart from these, it is also desirable to use C.I. Pigment Violet 19, C.I. Pigment Violet 23, and C.I. Pigment Green 36.

From the viewpoint of color reproducibility, preferably, the particle size of these water-insoluble coloring materials is 10 to 80 nm, and more preferably, 20 to 80 nm or less. The particle size is a volume average particle size measured with Microtrac UPA EX-150 manufactured by Nikkiso Co. Ltd. In this case, the ink is diluted by 100 to 200 times with deionized water.

The volume of water-insoluble coloring material contained in the ink used for carrying out the present invention is desirably 0.1 to 25 wt %, and more desirably, 1.0 to 15 wt % with respect to the total weight of ink. If the volume of water-insoluble coloring material is less than 0.1 wt %, then it may become difficult to achieve sufficient image density, and if it exceeds 25 wt %, then decline in ejection stability is liable to occur, due to a blockage in the nozzle, or the like. Moreover, it is preferable that the content ratio of the water-insoluble coloring material and the polymer dispersant described above, in the ink, is 100:1 to 1:2 in terms of a solid weight ratio, from the viewpoint of the ejection stability and the storage stability of the ink. These water-insoluble coloring materials may be used alone, or two or more types of coloring materials may be used in combination.

Furthermore, the ink used for carrying out the present invention may contain other additives, provided that they do not impede the beneficial effects of the present invention. Other additives may be, for example, a commonly known additive, such as an anti-drying agent (moisturizing agent), an anti-fading agent, an emulsion stabilizer, a permeation promoter, an ultraviolet absorber, an antiseptic agent, an antibacterial agent, a pH adjuster/buffering agent, a surface tension adjuster, an antifoaming agent, a viscosity adjuster, a dispersant, a dispersion stabilizer, an anti-rusting agent, a chelating agent, a fixing agent (polymer compound, polymer micro-particles), or the like.

An anti-drying agent is used appropriately for the purpose of preventing blockages due to drying of the inkjet ink in the ink spray ports of the nozzles used in an inkjet recording method. Preferably, the anti-drying agent is a water-soluble organic solvent having a lower vapor pressure than water. More specific examples of the anti-drying agent are: polyhydric alcohols, such as ethylene glycol, propylene glycol, diethylene glycol, polyethylene glycol, thiodiglycol, dithiodiglycol, 2-methyl-1,3-propanediol, 1,2,6-hexanetriol, an acetylene glycol derivative, glycerin, trimethylol propane, or the like; low alkyl ethers of polyhydric alcohols, such as ethylene glycol monomethyl (or ethyl) ether, diethylene glycol monomethyl (or ethyl) ether, triethylene glycol monoethyl (or butyl) ether, and the like; a heterocyclic compound, such as 2-pyrolidone, N-methyl-2-pyrolidone, 1,3-dimethyl-2-imidazolidinone, N-ethylmorpholine, or the like; a sulfur-containing compound, such as sulfolane, dimethyl sulfoxide, 3-sulfolene, or the like; a polyfunctional compound, such as diacetone alcohol, diethanol amine, or the like; or a urea derivative. Of these, a polyhydric alcohol, such as glycerine or diethylene glycol is more preferable. Furthermore, the anti-drying agent described above may be used alone, or two or more types of anti-drying agent may be used together in combination. Desirably, the content of these anti-drying agents in the ink is 10 to 50 wt %.

A permeation promoter is used, as appropriate, in order to make the inkjet ink permeate more readily into the paper. For the permeation promoter, it is possible to use an alcohol, such as ethanol, isopropanol, butanol, di(tri)ethylene glycol monobutyl ether, 1,2-hexanediol, or the like, or sodium lauryl sulfate, sodium oleate, a nonionic surface active agent, or the like. In general, these materials display sufficient effects when contained at a rate of 5 to 30 wt % in the ink. Preferably, a permeation promoter is added in an amount which prevents print bleeding or print-through effects.

An ultraviolet absorber is used in order to improve image conservation. For the ultraviolet absorber, it is possible to use; a benzotriazole compound as described in Japanese Patent Application Publication Nos. 58-185677, 61-190537, 2-782, 5-197075, and 9-34057, and the like; a benzophenone compound as described in Japanese Patent Application Publication Nos. 46-2784 and 5-194483, and U.S. Pat. No. 3,214,463, and the like; a cinnamic acid compound as described in Japanese Patent Application Publication Nos. 48-30492, 56-21141, and 10-88106, and the like; a triazine compound as described in Japanese Patent Application Publication Nos. 4-298503, 8-53427, 8-239368, 10-182621, and 8-501291, and the like; a compound as described in Research Disclosure No. 24239; or a so-called fluorescent brightening agent, which is a compound that absorbs ultraviolet light and generates fluorescent light, typical examples being a stilbene or a benzoxazole compound.

An anti-fading agent is used in order to improve image conservation. For the anti-fading agent, it is possible to use various types of organic or metallic complex anti-fading agents. The organic type of the anti-fading agent may be a hydroquinone, an alkoxyphenol, a dialkoxyphenol, a phenol, an aniline, an amine, an indane, a chromane, an alkoxyaniline, a heterocyclic compound, or the like. The metallic complex type of the anti-fading agent may be a nickel complex, a zinc complex, or the like. More specifically, it is possible to use a compound as described in the patents cited in Research Disclosure Nos. 17643 (volume VII, sections I to J), 15162, 18716 (p. 650, left-hand column), 36544 (p. 527), 307105 (p. 872), or 15162, or a compound included in the general formulae and examples of typical compounds described in Japanese Patent Application Publication No. 62-215272, pages 127 to 137.

Examples of an anti-rusting agent are: sodium dehydroacetate, sodium benzoate, sodium pyridine thione-1-oxide, p-hydroxybenzoate ethyl ester, 1,2-benzisothiazoline-3-one, or a salt thereof, or the like. It is desirable to use these materials at a concentration of 0.02 to 1.00 wt % in the ink.

The pH adjuster or buffering agent preferably has a buffer function in the pH range from (the critical pH+0.1) to (the critical pH+3.0), and preferably, from (the critical pH+0.5) to (the critical pH+2.5). In this case, the critical pH is the pH at which the polymer dispersant described above displays pH stimulus responsive properties. Moreover, it is also possible to use a pH adjuster or buffering agent which has a narrower or broader range of the pH buffer region than that described above. If the buffering agent has no buffer action at pH above (the critical pH+0.1), then the ink viscosity will increase during storage of the ink and the dispersion of coloring material becomes more liable to aggregate. Moreover, if the buffering agent has no buffer action at pH below (the critical pH+3.0), then the fixing characteristics of the printed image are liable to decline.

Examples of the pH buffering agent described above are: phosphoric acid, boric acid, silicic acid, acetic acid, carbonic acid, citric acid, tartaric acid, malleinic acid, phthalic acid, lactic acid, hydrochloric acid, or alkali metal salts, ammonium salts, triethyl amine salts, or triethanol amine salts of these acids, or mixtures of these acids with sodium hydroxide or potassium hydroxide; mixtures of hydrochloric acid with tris(hydroxymethyl)aminomethane, 2,4,6-trimethyl pyridine, 2-amino-2-methyl-1,3-propanediol, or sodium diethyl barbiturate; or the like.

The surface tension adjuster is, for example, a nonionic, cationic, anionic or betaine type surface active agent. In order that droplets can be ejected satisfactorily in an inkjet apparatus, the added amount of the surface tension adjuster is, desirably, an amount which adjusts the surface tension of the ink to 20 to 60 mN/m, and more desirably, 20 to 45 mN/m, and even more desirably, 25 to 40 mN/m. In this case, a hydrocarbon type of the surface active agent may be used, for instance. The hydrocarbon type of the surface active agent includes: an anionic surface active agent such as a fatty acid salt, an alkyl sulfate ester salt, an alkyl benzene sulfonate salt, an alkyl naphthalene sulfonate salt, a dialkyl sulfosuccinate salt, an alkyl phosphate ester salt, a condensation product of naphthalene sulfonate with formalin, a polyoxyethylene alkyl sulfonate ester salt, or the like; or a nonionic surface active agent, such as a polyoxyethylene alkyl ether, a polyoxyethylene alkyl allyl ether, a polyoxyethylene fatty acid ester, a sorbitan fatty acid ester, a polyoxyethylene sorbitan fatty acid ester, a polyoxyethylene alkyl amine, a glycerine fatty acid ester, an oxyethylene oxypropylene block copolymer, and the like. It is also desirable to use SURFYNOLS (Air Products & Chemicals Co. Ltd.), which is an acetylene-based polyoxyethylene oxide surface active agent. An amine oxide type of amphoteric surface active agent, such as N,N-dimethyl-N-alkyl amine oxide, is also desirable. Moreover, it is also possible to use the surface active agents cited in Japanese Patent Application Publication No. 59-157636, pages 37 and 38, and Research Disclosure No. 308119 (1989). Furthermore, it is also possible to use a fluorine (alkyl fluoride) type, or silicon type of surface active agent such as those described in Japanese Patent Application Publication Nos. 2003-322926, 2004-325707, and 2004-309806. It is also possible to use a surface tension adjuster of this kind as an anti-foaming agent; and a fluoride or silicone compound, or a chelating agent, such as EDTA, can also be used.

Moreover, desirably, the viscosity of ink used for the inkjet apparatus according to the present invention is 30 mPa·s or less. Preferably, the viscosity is adjusted to 20 mPa·s or below.

### Water-Soluble Organic Solvent

The solvent in the ink for inkjet recording is a water-soluble organic solvent having a solubility parameter (SP value) (J/cm³)^{1/2} from (the SP value of the hydrophilic block part in the polymer dispersant−4.0) to (the SP value of the hydrophilic block in the dispersant+16.0), and desirably, (the SP value of the hydrophilic block in the dispersant+0.0) to (the SP value of the hydrophilic block in the dispersant+16.0), and more desirably, (the SP value of the hydrophilic block in the dispersant+0.0) to (the SP value of the hydrophilic block in the dispersant+10.0). If the solubility parameter (J/cm³)^{1/2} of the water-soluble organic solvent is lower than (the SP value of the hydrophilic block in the dispersant−4.0), then in a printing process using an inkjet printer, blockages of the nozzles of the inkjet head occur and ink ejection ceases to be possible when a large amount of the moisture in the ink evaporates. On the other hand, if the solubility parameter is higher than (the SP value of the hydrophilic block part in the polymer dispersant+16.0), then ink ejection becomes unstable. Moreover, it is desirable that the SP value of the water-soluble organic solvent should be higher than (the SP value of the hydrophilic block part in the polymer dispersant+4.0), since this makes ink ejection more stable.

The water-soluble organic solvent may also be a mixed solvent combined by two or more types of water-soluble organic solvent. In this case, the SP value for the mixed solvent is calculated in consideration of SP value for each pure water-soluble organic solvent and the combination ratio. More specifically, the SP value for the mixed solvent is obtained by multiplying the SP values for pure water-soluble organic solvents by the weight ratio of the water-soluble organic solvents with respect to the total of the mixed solvent, respectively, then summing up all the products. Moreover, in cases where a mixed solvent of this kind is used, a solid, water-soluble organic compound may be added, provided that the mixed solvent is liquid.

The water-soluble organic solvent of this kind is, for example: a lower alcohol, such as methyl alcohol, ethyl alcohol, n-propyl alcohol, isopropyl alcohol, n-butyl alcohol, sec-butyl alcohol, tert-butyl alcohol, or the like; a diol, such as ethylene glycol, diethylene glycol, triethylene glycol, tetraethylene glycol, propylene glycol, dipropylene glycol, tripropylene glycol, 1,2-butane diol, 1,3-butane diol, 1,4-butane diol, thiodiglycol, 1,2-cyclohexane diol, 1,4-cyclohexane diol, 1,5-hexane diol, 1,6-hexane diol, or the like; a triol such as glycerine, 1,2,4-butane triol, 1,2,6-hexane triol, 1,2,5-pentane triol, or the like; a hindered alcohol, such as trimethylol propane, trimethylol ethane, neopentyl glycol, pentaerythritol, or the like; a glycol ether, such as ethylene glycol monomethyl ether, ethylene glycol monoethyl ether, ethylene glycol monoisopropyl ether, ethylene glycol monoallyl ether, diethylene glycol monomethyl ether, diethylene glycol monoethyl ether, triethylene glycol monomethyl ether, triethylene glycol monoethyl ether, propylene glycol monomethyl ether, dipropylene glycol monomethyl ether, or the like; or dimethyl sulphoxide, glycerine monoallyl ether, polyethylene glycol, N-methyl-2-pyrolidone, 2-pyrolidone, γ-butyrolactone, 1,3-dimethyl-2-imidazolidinone, sulfolane, β-dihydroxy ethyl urea, urea, acetonylacetone, dimethyl formamide, dimethyl acetamide, acetone, diacetone alcohol, tetrahydrofuran, dioxane, or the like.

As a desirable example of a water-soluble organic solvent, it is possible to use a compound containing at least a cyclic ether. Preferably, the cyclic ether is at least one ether selected from dimethylfuran, tetrahydrofuran, methyl tetrahydrofuran, dimethoxy tetrahydrofuran, and dioxane, and more preferably, the cyclic ether is tetrahydrofuran.

One of preferred examples of a water-soluble organic solvent is a compound containing at least a monoalkyl ether of a polyhydric alcohol. Preferably, the monoalkyl ether of the polyhydric alcohol described above is at least one type of ether selected from a diethylene glycol monomethyl ether, a diethylene glycol monoethyl ether, a diethylene glycol monobutyl ether, a dipropylene glycol monomethyl ether, a triethylene glycol monomethyl ether, and a tripropylene glycol monomethyl ether; and more preferably, the monoalkyl ether of the polyhydric alcohol is a diethylene glycol monobutyl ether and/or a tripropylene glycol monomethyl ether.

Of these, it is desirable to use a water-soluble organic solvent having a boiling point of 120° C. or above, since this prevents the ink condensation at the front tip portion of the nozzle. Desirably, the weight ratio of the water-soluble organic solvent to the total ink is 5 to 50 wt %, and more desirably, 10 to 30 wt %.

### Medium/Recording Medium

Medium for the image recording apparatus according to the present invention may be any medium such as recording paper, and film for recording images, on which the ink can be solidified. The medium for the image recording apparatus also includes medium used for temporary recording, such as a transfer drum, transfer belt, transfer sheet, or the like, in the case of a transfer system.

There follows a description of media used when forming images by using the ink set described above, and more specifically, recording papers and recording films which are permeable or non-permeable with respect to the liquid are described below.

The supporting body of the recording paper and the recording film is made of a chemical pulp, such as LBKP or NBKP, a mechanical pulp, such as GP, PGW, RMP, TMP, CTMP, CMP, CGP, or the like, or a recycled paper pulp, such as DIP, which may be mixed, according to requirements, with additives such as a pigment, a binder, a sizing agent, a fixing agent, a cationic agent, a paper strength enhancer, or the like, as commonly known in the related art. The supporting body of the recording paper may be manufactured by means of one of variety of apparatuses, such as a Fourdrinier paper machine, a cylinder paper machine, or the like. Apart from these supporting bodies, it is also possible to use a synthetic paper or a plastic film sheet, and desirably, the thickness of the supporting body is 10 to 250 μm and the basis weight is 10 to 250 g/m². It is possible to provide an ink receiving layer and a back coating layer directly on the supporting body. It is also possible to first carry out a sizing treatment using starch, polyvinyl alcohol, or the like, or provide an undercoat layer, prior to forming an ink receiving layer and a back coating layer. Moreover, the supporting body may also be subjected to a flattening process in a calender apparatus, such as a machine calender, a TG calender, a soft calender, or the like. In the present embodiment, desirably, a paper coated on both sides with polyolefin (for example, polyethylene, polystyrene, polyethylene terephthalate, polybuten, or a copolymer of these) is used as the supporting body. Desirably, a white pigment (for example, titanium oxide or zinc oxide), or a tinting dye (for example, cobalt blue, ultramarine blue, neodium oxide) is added to the polyolefin.

The ink receiving layer provided on the supporting body contains pigment or aqueous binder. The pigment is desirably a white pigment, and possible examples of a white pigment include: an inorganic white pigment, such as calcium carbonate, kaolin, talc, clay, diatomaceous earth, synthetic non-crystalline silica, aluminum silicate, magnesium silicate, calcium silicate, aluminum hydroxide, alumina, lithopone, zeolite, barium sulfate, calcium sulfate, titanium dioxide, zinc sulfide, zinc carbonate, or the like; and an organic pigment, such as a styrene pigment, an acrylic pigment, a urea resin, a melamine resin, or the like. Desirably, the white pigment contained in the ink receiving layer is a porous inorganic pigment, and a particularly suitable pigment is a synthetic non-crystalline silica, or the like, which has a large porous surface area. For the synthetic non-crystalline silica, it is possible to use either an anhydrous silicate obtained by a dry manufacturing method or a hydrous silicate obtained by a wet manufacturing method, but it is particularly desirable to use a hydrous silicate.

Possible examples of an aqueous binder contained in the ink receiving layer are water-soluble macromolecules, such as polyvinyl alcohol, silanol-modified polyvinyl alcohol, starch, cationized starch, casein, gelatin, carboxymethyl cellulose, hydroxyethyl cellulose, polyvinyl pyrrolidone, polyalkylene oxide, a polyalkylene oxide derivative, or the like, or water-dispersible macromolecules, such as styrene butadiene latex, acrylic emulsion, or the like. These aqueous binders can be used singly or two or more types of aqueous binder can be used in combination. In the present embodiment, of these substances, polyvinyl alcohol and silanol-modified polyvinyl alcohol are especially suitable from the viewpoint of adherence to the pigment, and resistance to peeling of the ink receiving layer. In addition to a pigment and an aqueous binder, the ink receiving layer may also contain a dye mordant, a water resisting agent, a light resistance enhancer, a surface active agent, and other additives.

Desirably, the dye mordant added to the ink receiving layer is immobilized. For this reason, it is desirable to use a polymer dye mordant. Polymer dye mordants are described in the specifications of Japanese Patent Application Publication Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236, and U.S. Pat. Nos. 2,484,430, 2,548,564, 3,148,061, 3,309,690, 4,115,124, 4,124,386, 4,193,800, 4,273,853, 4,282,305, and 4,450,224. A light receiving material containing a polymer dye mordant as described in Japanese Patent Application Publication No. 1-161236, pages 212 to 215, is particularly desirable. If the polymer dye mordant described Japanese Patent Application Publication No. 1-161236 is used, then an image of excellent quality is obtained and the light resistance of the image is improved.

The water resisting agent is effective in waterproofing the image, and a cationic resin is particularly desirable as a water resisting agent of this kind. Possible examples of the cationic resin are: polyamide polyamine epichlorohydrin, polyethylene imine, polyamine sulfone, dimethyl diallyl ammonium chloride polymer, cationic polyacrylamide, colloidal silica, or the like, and of these cationic resins, polyamide polyamine epichlorohydrin is especially desirable. The content of the cationic resin is desirably 1 to 15 wt %, and especially desirably, 3 to 10 wt %, with respect to the total solid component of the ink receiving layer.

Possible examples of a light resistance enhancer are zinc sulfate, zinc oxide, a hindered amine antioxidizing agent, a benzophenone or benzotriazole ultraviolet light absorber, or the like. Of these, zinc sulfate is particularly desirable.

A surface active agent acts as a coating aid, a peelability improving agent, a slidability improving agent or an antistatic agent. Surface active agents are described in Japanese Patent Application Publication Nos. 62-173463 and 62-183457. Instead of a surface active agent, it is also possible to use an organic fluoro compound. Desirably, the organic fluoro compound has hydrophobic properties. Examples of the organic fluoro compound include: a fluorine-containing surface active agent, an oily fluorine-containing compound (for example, a fluorinated oil) and a solid fluorine-containing compound resin (for example, an ethylene tetrafluoride resin). An organic fluoro compound is described in Japanese Patent Application Publication Nos. 57-9053 (columns 8 to 17), 61-20994, 62-135826, 2003-322926, 2004-325707, and 2004-309806, and the like. Examples of other additives which can be added to the ink receiving layer are: a pigment dispersing agent, a viscosity raising agent, an antifoaming agent, a dye, a fluorescent brightening agent, a preservative, a pH adjuster, a matting agent, a hardening agent, and the like. Furthermore, there may be one or two ink receiving layers.

Moreover, a back coating layer may also be provided on the recording paper and recording film, and components which can be added to this layer are, for example, a white pigment, an aqueous binder, and the like. Examples of a white pigment which could be added to the back coating layer are: inorganic white pigments, such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic non-crystalline silica, colloidal silica, colloidal alumina, pseudo-boehmite, aluminum hydroxide, alumina, lithopone, zeolite, hydrated halloysite, magnesium carbonate, magnesium hydroxide, or the like; or organic pigments, such as a styrene plastic pigment, an acryl plastic pigment, a polyethylene, micro-capsules, urea resin, melamine resin, or the like.

Possible examples of an aqueous binder contained in the back coating layer are water-soluble polymer, such as a styrene/maleic acid salt copolymer, a styrene/acrylic acid salt copolymer, polyvinyl alcohol, silanol-modified polyvinyl alcohol, starch, cationized starch, casein, gelatin, carboxymethyl cellulose, hydroxyethyl cellulose, polyvinyl pyrrolidone, or the like, or water-dispersible polymer, such as styrene butadiene latex, acrylic emulsion, or the like. Other additives which can be contained in the back coating layer are, for example: an anti-foaming agent, a foam suppressant, a dye, a fluorescent brightener, a preservative, a water resisting agent, and the like.

A polymer latex may be added to the compositional layers (including the back coating layer) of the inkjet recording paper and recording film. The polymer latex is used in order to improve the properties of the film, such as stabilizing dimensions, preventing curl, preventing adhesion, and preventing cracking of the film. The polymer latex is described in Japanese Patent Application Publication Nos. 62-245258, 62-1316648, and 62-110066. When a polymer latex having a low glass transition temperature (or 40° C. or lower) is added to a layer containing a dye mordant, then cracking and curling of the layer can be prevented. Moreover, curling can be prevented by adding a polymer latex to the back coating layer, even in cases of a polymer latex having a high glass transition temperature.

A transfer belt or drum forming an intermediate body (transfer medium) is desirably made of a material having good separability which can separate readily from the ink image, as well as having good heat resistance and durability; silicone rubber, fluorine resin, fluorosilicone rubber, and the like, and modified forms of these, are desirable. Other materials that may be used are: chloroprene rubber, nitrile rubber, ethylene propylene rubber, natural rubber, styrene rubber, isopropylene rubber, butadiene rubber, ethylene/propylene/butadiene polymer, nitrile butadiene rubber, and the like.

Moreover, it is also possible to form an elastic layer by applying various coatings having separability characteristics, to the surface (ink layer supporting face) of the various types of rubber material described above. Desirable coating materials are a silicone coating and a fluorine coating.

### Inkjet Recording Method

The image recording method and image recording apparatus according to the present invention are not limited to an inkjet recording system, and they may also use other commonly known image recording systems, such as a drop-on-demand system (pressure pulse system) which uses the vibrational pressure of a piezo element, an acoustic inkjet system which converts an electrical signal into an acoustic beam, radiates the acoustic beam on ink, and causes ink to be ejected by the generated radiation pressure, or a thermal inkjet system which uses the pressure generated by air bubbles formed by heating the ink, or the like. The inkjet recording system includes: systems which perform a large number of ejections of small volumes of inks having low density, known as photo inks; systems which improve image quality by using a plurality of inks having different densities and substantially the same color tone; and systems which use colorless, transparent inks.

### General Composition of Inkjet Recording Apparatus

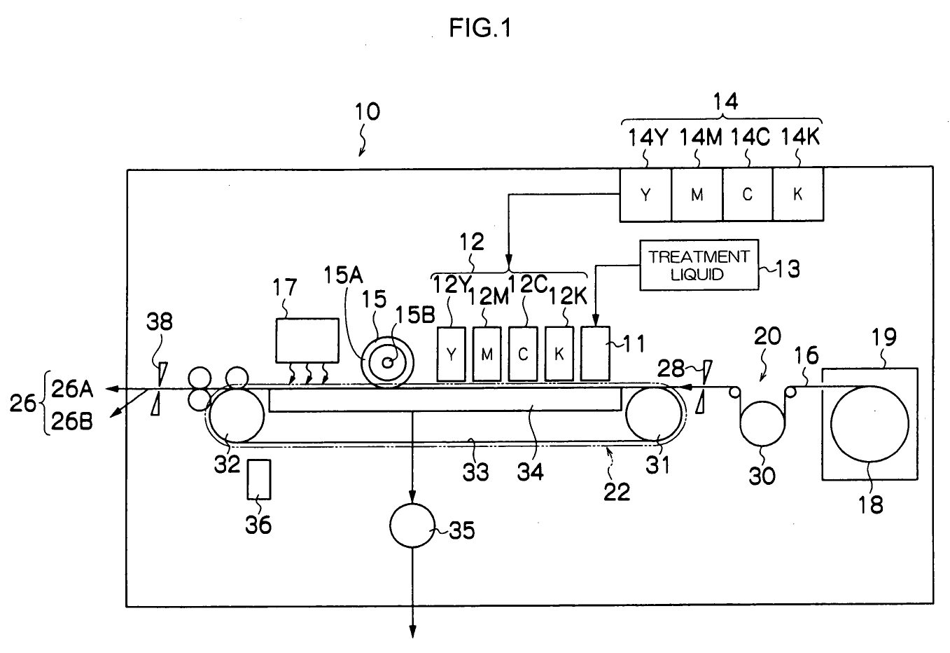

FIG. 1 is a general schematic drawing showing an inkjet recording apparatus forming one mode of an image forming apparatus according to an embodiment of the present invention. As shown in FIG. 1, this inkjet recording apparatus 10 comprises: a treatment liquid head (corresponding to a treatment liquid application device) 11 for ejecting treatment liquid; a print unit 12 having a plurality of print heads (corresponding to ink liquid ejection devices) 12K, 12C, 12M and 12Y, provided corresponding to respective colors, in order to eject inks of respective colors, namely, black (K), cyan (C), magenta (M), and yellow (Y); a treatment liquid storing and loading unit 13 which stores treatment liquid for supply to the treatment liquid head 11; an ink storing and loading unit 14 which stores colored inks for supply to the print heads 12K, 12C, 12M and 12Y; a solvent-absorbing roller (corresponding to a solvent absorbing device) 15, disposed after the print unit 12; a medium supply unit 18 which supplies a recording medium 16; a decurling unit 20 which removes curl from the recording medium 16; a suction belt conveyance unit (corresponding to a conveyance device) 22, disposed in opposition to the nozzle surfaces (liquid ejection surfaces) of the treatment liquid head 11 and the print unit 12, which conveys the recording medium 16 while keeping the recording medium 16 flat; and a print output unit 26 which outputs recorded recording medium 16 (printed matter) to the exterior.

As regards the supply system for the recording medium 16, in FIG. 1, a magazine 19 for rolled paper (continuous paper) is shown as an example of the medium supply unit 18; however, a plurality of magazines with papers of different paper width and quality may be jointly provided. Moreover, papers may be supplied in cassettes that contain cut papers loaded in layers and that are used jointly or in lieu of magazines for rolled papers.

In the case of a configuration in which a plurality of types of recording medium can be used, it is preferable that an information recording medium such as a bar code and a wireless tag containing information about the type of recording medium is attached to the magazine, and by reading the information contained in the information recording medium with a predetermined reading device, the type of recording medium (media type) to be used is automatically determined, and ejection is controlled so that the treatment liquid and ink are ejected in an appropriate manner depending on the type of medium.

The recording medium 16 delivered from the medium supply unit 18 retains curl due to having been loaded in the magazine 19. In order to remove the curl, heat is applied to the recording medium 16 in the decurling unit 20 by a heating drum 30 in the direction opposite to the curl direction in the magazine. In this case, the heating temperature is preferably controlled in such a manner that the medium has a curl in which the surface on which the print is to be made is slightly rounded in the outward direction.

In the case of the configuration in which roll paper is used, a cutter (a first cutter) 28 is provided as shown in FIG. 1, and the continuous paper is cut to a desired size by the cutter 28. When cut paper is used, the cutter 28 is not required.

After decurling in the decurling unit 24, the cut recording medium 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the print unit 12 forms a horizontal plane (flat plane).

The belt 33 has a width that is greater than the width of the recording medium 16, and a plurality of suction apertures (not shown) are formed on the belt surface. A suction chamber 34 is disposed in a position facing the nozzle surface of the print unit 12 on the interior side of the belt 33 which is set around the rollers 31 and 32; and the suction chamber 34 provides suction with a fan 35 to generate a negative pressure, thereby holding the recording medium 16 onto the belt 33 by suction.

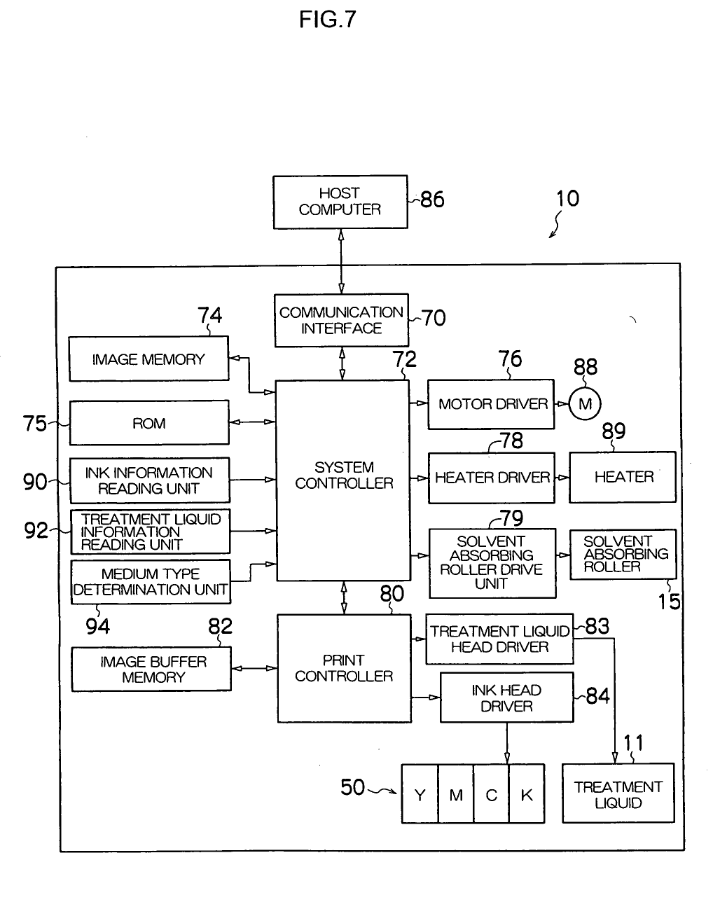

The belt 33 is driven in the counterclockwise direction in FIG. 1 by the motive force of a motor (indicated by reference numeral 88 in FIG. 7) being transmitted to at least one of the rollers 31 and 32, which the belt 33 is set around, and the recording medium 16 held on the belt 33 is conveyed from right to left in FIG. 1.

Instead of a suction belt conveyance unit 22, it might also be possible to use a roller nip conveyance mechanism. However, since the print region passes through the roller nip, the printed surface of the paper makes contact with the rollers immediately after printing, and hence smearing of the image is liable to occur. Therefore, a suction belt conveyance mechanism in which nothing comes into contact with the image surface in the printing area is preferable. The attraction method is not limited to attraction by suction (vacuum attraction) as described above, and a method based on electrostatic attraction may also be used.

Since ink adheres to the belt 33 when a marginless print job or the like is performed, a belt cleaning unit 36 is disposed in a predetermined position (a suitable position outside the printing area) on the exterior side of the belt 33. Although the details of the configuration of the belt cleaning unit 36 are not shown, examples thereof may include a configuration in which the belt 33 is nipped with a cleaning roller such as a brush roller and a water absorbent roller, an air blow configuration in which clean air is blown onto the belt 33, or a combination of these. In the case of the configuration in which the belt 33 is nipped with the cleaning roller, it is preferable to make the linear velocity of the cleaning roller different to that of the belt 33, in order to improve the cleaning effect.

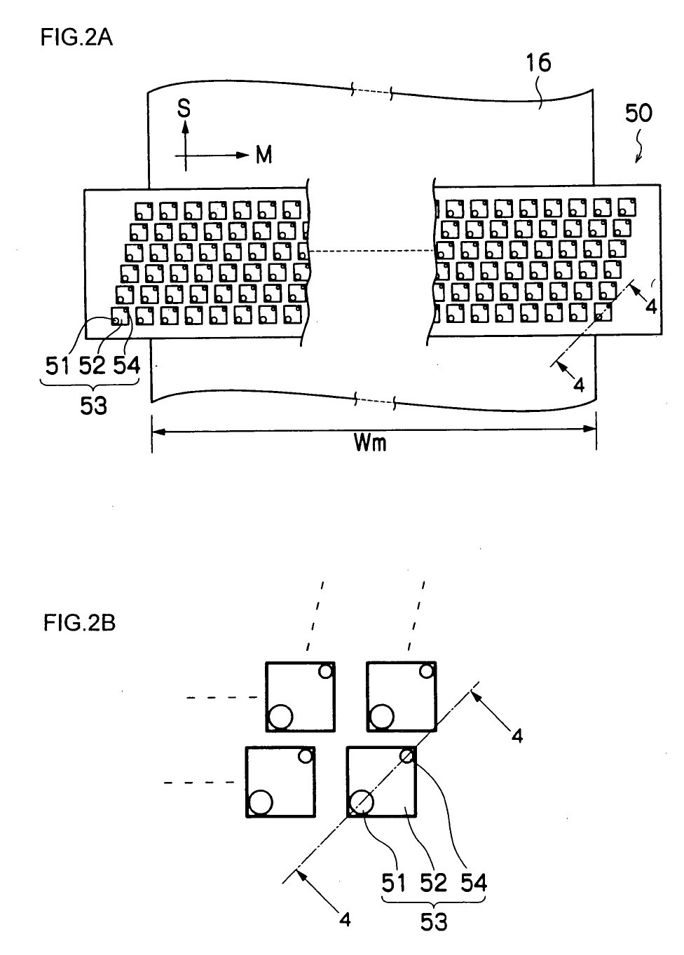

The treatment liquid head 11 and the print heads 12K, 12M, 12C and 12Y are full line heads having a length corresponding to the maximum width of the recording medium 16 used with the inkjet recording apparatus 10 (see FIGS. 2A and 2B), and comprising nozzles for ejecting ink or nozzles for ejecting treatment liquid arranged on a nozzle face through a length exceeding at least one edge of the maximum-size recording paper (the full width of the printable range).

As shown in FIG. 1, the heads 12K, 12C, 12M and 12Y of the print unit 12 are arranged in the sequence of the colors, black (K), cyan (C), magenta (M) and yellow (Y), from the upstream side, in the direction of conveyance of the recording medium 16, and the treatment liquid head 11 is disposed to the upstream side with respect to the print unit 12 (before the print unit 12). The heads 11, 12K, 12C, 12M and 12Y are disposed in fixed positions in such a manner that they extend in a direction substantially perpendicular to the conveyance direction of the recording medium 16.

By means of this head arrangement, it is possible to apply a treatment liquid to the recording surface (print surface) of the recording medium 16 by the treatment liquid head 11, before ejecting droplets of colored inks from the print unit 12. Furthermore, a color image can be formed on the recording medium 16 by ejecting inks of different colors from the print heads 12K, 12C, 12M, and 12Y, respectively, onto the recording medium 16 to which the treatment liquid has been applied, while the recording medium 16 is conveyed by means of the suction belt conveyance unit 22. At this time, the treatment liquid that has been applied on the recording medium 16 and the ink liquid that is being applied on the recording medium 16 react with each other on the recording medium 16 to form aggregate.

By adopting a configuration in which a full line treatment liquid head 11 and full line heads 12K, 12C, 12M and 12Y having nozzle rows covering the full paper width are provided in this way, it is possible to record an image on the full surface of the recording medium 16 by performing just one operation of relatively moving the medium 16 and the print unit 12, in the paper conveyance direction (the sub-scanning direction), (in other words, by means of one sub-scanning action). Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light and/or dark inks and special color inks can be added as required. For example, a configuration is possible in which print heads for ejecting light-colored inks such as light cyan and light magenta are added. Furthermore, there are no particular restrictions of the sequence in which the heads of respective colors are arranged.

The treatment liquid storing and loading unit 13 has a treatment liquid tank for storing treatment liquid, and the tank is connected to the treatment liquid head 11 via necessary tubing channels. The treatment liquid supplied from the treatment liquid tank is ejected in the form of droplets from the treatment liquid head 11. The treatment liquid storing and loading unit 13 has a reporting device (display device, alarm sound generating device) for issuing a report when the remaining amount of treatment liquid has become low.

The ink storing and loading unit 14 has ink tanks 14K, 14C, 14M, 14Y for storing the inks of the colors corresponding to the print heads 12K, 12C, 12M, and 12Y, and the tanks are connected to the print heads 12K, 12C, 12M, and 12Y through prescribed channels (not shown). The ink storing and loading unit 14 also comprises a warning device (for example, a display device and/or an alarm sound generator) for warning when the remaining amount of any ink is low, and has a mechanism for preventing loading errors among the colors.

The surface of the solvent absorbing roller 15 is made of a porous member 15A which has a length corresponding to the maximum width of the recording medium 16 used in the inkjet recording apparatus 10. The rotational axle 15B of the solvent absorbing roller 15 extends in a direction (main scanning direction) perpendicular to the conveyance direction of the recording medium 16. The solvent absorbing roller 15 supported rotatably on the rotational axle 15B can be rotated in accordance with the conveyance speed of the recording medium 16, in such a manner that the relative speed of the surface of the solvent absorbing roller 15 with respect to the recording medium 16 becomes zero. In this way, disturbance of the image due to rubbing of the ink is prevented.

The solvent absorbing roller 15 may achieve a length corresponding to the full width of the recording medium 16 by means of one (a single) long roller member, and may also achieve the required length by arranging a plurality of roller modules divided in a direction (main scanning direction) substantially perpendicular to the conveyance direction of the recording medium 16. Furthermore, it is possible to adopt a composition in which a plurality of rows of solvent absorbing rollers are disposed in line with the conveyance direction of the recording medium 16.

Although not shown in FIG. 1, an elevator mechanism for raising and lowering the solvent absorbing roller 15 with respect to the recording medium 16 is provided. By controlling the elevator mechanism in accordance with instructions from the system control system described hereinafter, the position of the solvent absorbing roller 15 (the relative position thereof in the direction perpendicular to the recording surface of the recording medium 16) can be adjusted. In this way, it is possible to alter the contact pressure between the solvent absorbing roller 15 and the recording medium 16, or the clearance between the solvent absorbing roller 15 and the recording medium 16. In the case of a composition having a plurality of roller modules, a desirable mode is one in which a mechanism for controlling the vertical position is provided with respect to each roller module.

By moving the recording medium 16 in the direction of conveyance while the solvent absorbing roller 15 is made to contact the ink on the recording medium 16, the solvent on the recording medium 16 (the solvent separated from the coloring material) is absorbed by the solvent absorbing roller 15 due to the capillary force of the porous member 15A. In the ink from which the excess solvent has been removed by the solvent absorbing roller 15 in this way, the coupling force between the coloring materials increases and the coloring materials become fixed onto the recording medium 16.

In the present embodiment, as a device for absorbing and removing the solvent, the solvent absorbing roller 15 including the porous member 15A is used. However, the form of the solvent absorbing device is not limited to being roller-form, and it may also be belt-form. A heating unit 17 is further provided on the downstream side of the solvent absorbing roller 15, which absorbs and removes the major part of the solvent. This heating unit 17 blows a heated air having a prescribed temperature of around 30° C. or above, directly onto the recording medium 16, thereby causing the residual solvent in the aggregate on the recording medium 16 to evaporate further. Thereby, the polymer micro-particles in the aggregate dry and harden. Consequently, the coloring material becomes fixed in the form of a film onto the recording medium 16, and a print having excellent rubbing resistance, water resistance and fixing properties can be obtained.

In the example of a method of heating the aggregate described in the present embodiment, the coloring material is fixed by blowing a heated wind directly on the aggregate on the recording medium 16, but the invention is not limited to this method. For example, a method where heat is applied by means of a heater may also be adopted. Furthermore, in the present embodiment, the heating unit 17 is disposed on the downstream side of the solvent absorbing roller 15, but the invention is not limited to this, and provided that a composition capable of applying heat after the generation of the aggregate is achieved, then it may also be disposed on the upstream side of the solvent absorbing roller 15.

The printed matter generated in this manner (i.e., the resulting matter generated by printing) is outputted from the print output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to print output units 26A and 26B, respectively.

When the target print and the test print are simultaneously formed in parallel on the same large sheet of paper, the test print portion is cut and separated by a cutter (second cutter) 38. The cutter 38 is disposed in front of the print output unit 26, and is used for cutting the test print portion from the target print portion when a test print has been performed in the blank portion of the paper.

### Structure of Print Head

Next, the structure of the print head will be described. The print heads 12K, 12C, 12M, and 12Y of the respective ink colors have the same structure, and a reference numeral 50 is hereinafter designated to any of the print heads.

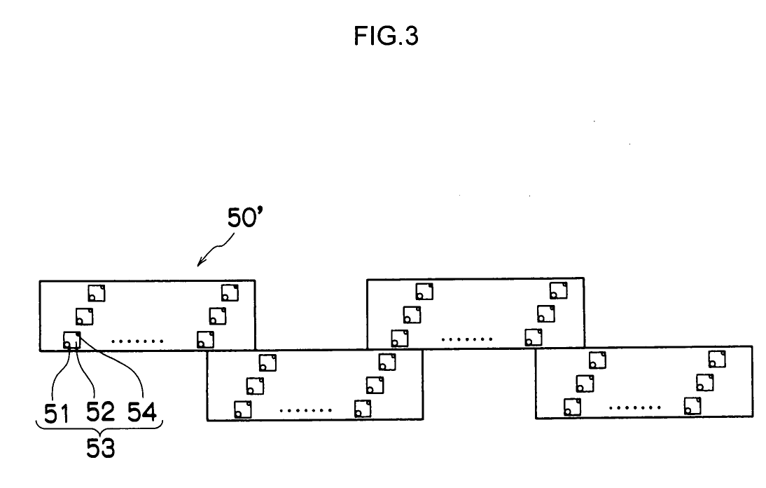

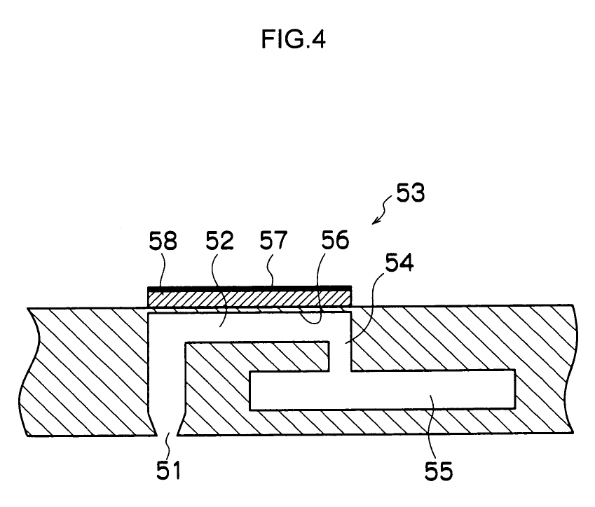

FIG. 2A is a perspective plan view showing an example of the configuration of the print head 50, FIG. 2B is an enlarged view of a portion thereof, FIG. 3 is a perspective plan view showing another example of the configuration of the print head 50, and FIG. 4 is a cross-sectional view taken along the line 4-4 in FIGS. 2A and 2B, showing the inner structure of a droplet ejection element (an ink chamber unit for one nozzle 51).

The nozzle pitch in the print head 50 is required to be minimized in order to maximize the density of the dots printed on the surface of the recording medium 16. As shown in FIGS. 2A and 2B, the print head 50 according to the present embodiment includes ink chamber units (droplet ejection elements) 53, each having a nozzle 51 forming an ink droplet ejection port, a pressure chamber 52 corresponding to the nozzle 51, and the like. The ink chamber units 53 are arranged two-dimensionally in the form of a staggered matrix. Hence, the effective nozzle interval (the projected nozzle pitch) resulting from the projection of the nozzles 51 so that the projected nozzles are arranged in the lengthwise direction of the head (the direction perpendicular to the paper conveyance direction) is reduced and high nozzle density is achieved.

The mode of forming one or more nozzle rows through a length corresponding to the entire width Wm of the recording medium 16 in a direction (direction of arrow M: main scanning direction) substantially perpendicular to the conveyance direction of the recording medium 16 (direction of arrow S: sub-scanning direction) is not limited to the examples described above. For example, instead of the configuration in FIG. 2A, as shown in FIG. 3, a line head having nozzle rows of a length corresponding to the entire width of the recording medium 16 can be formed by arranging and combining, in a staggered matrix, short head modules 50′ having a plurality of nozzles 51 arrayed in a two-dimensional fashion.

As shown in FIGS. 2A and 2B, the planar shape of the pressure chamber 52 provided for each nozzle 51 is substantially a square, and an outlet to the nozzle 51 and an inlet of supplied ink (supply port) 54 are respectively disposed in both corners on a diagonal line of the square. The shape of the pressure chamber 52 is not limited to the above-mentioned example and various modes are possible in which the planar shape is a polygonal shape such as a quadrilateral shape (rhombic shape, rectangular shape, or the like), a pentagonal shape, and a hexagonal shape, a circular shape, elliptical shape, or the like.

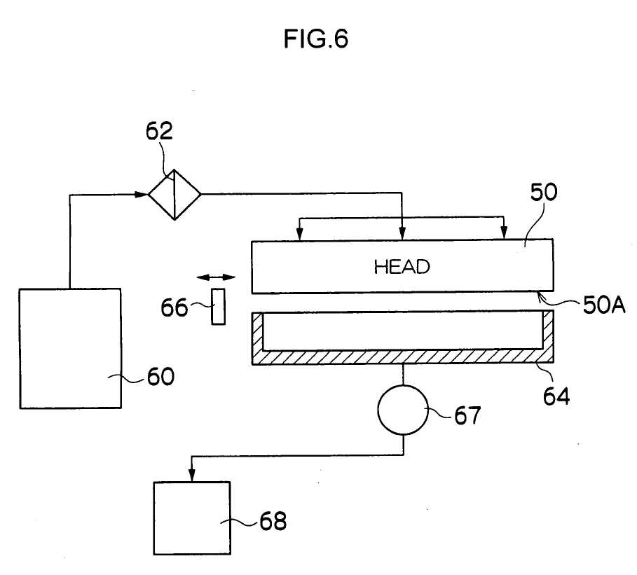

As shown in FIG. 4, each pressure chamber 52 is connected to a common channel 55 through the supply port 54. The common channel 55 is connected to an ink tank 60 (not shown in FIG. 4, but shown in FIG. 6) which is a base tank that supplies ink. The ink supplied from the ink tank 60 is delivered through the common flow channel 55 in FIG. 4 to the pressure chambers 52.

An actuator 58 provided with an individual electrode 57 is bonded to a pressure plate (a diaphragm that also serves as a common electrode) 56 which forms one portion (in FIG. 4, the ceiling) of the pressure chamber 52. When a drive voltage is applied to the individual electrode 57 and the common electrode, the actuator 58 deforms, thereby changing the volume of the pressure chamber 52. This causes a pressure change resulting in ink being ejected from the nozzle 51. As the actuator 58, it is possible to use a piezoelectric element using a piezoelectric material, such as lead zirconate titanate, barium titanate, or the like. When the displacement of the actuator 58 is reduced and the actuator 58 returns to its original position after the ejecting ink, new ink is supplied to the pressure chamber 52 from the common channel 55 via the supply port 54.

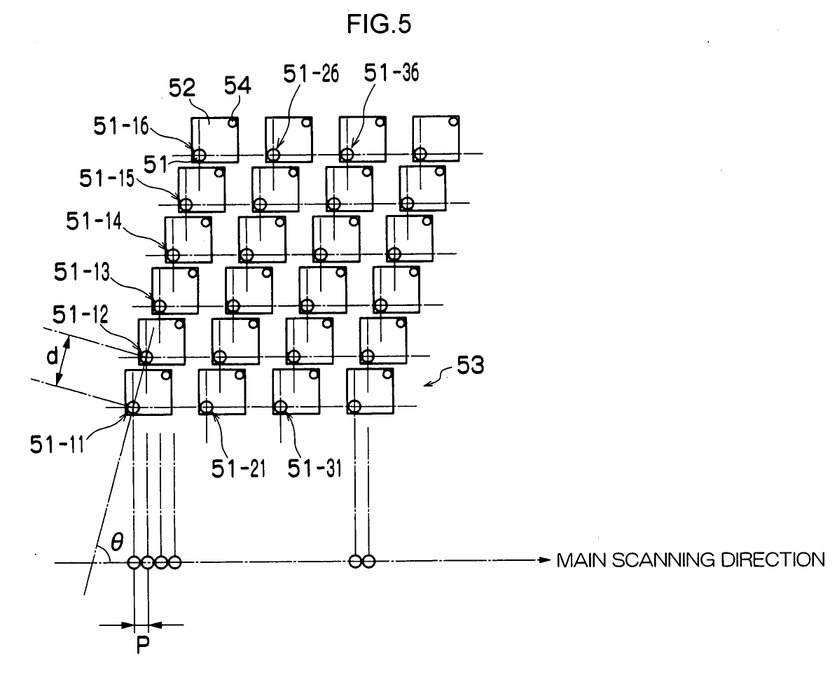

As shown in FIG. 5, the high-density nozzle head according to the present example is achieved by arranging a plurality of ink chamber units 53 having the above-described structure in a lattice fashion based on a fixed arrangement pattern, in a row direction which corresponds to the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. With such configuration, it is possible to achieve a nozzle row with a high nozzle density.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, . . . , 51-26 are treated as another block; the nozzles 51-31, . . . , 51-36 are treated as another block; . . . ); and one line is printed in the width direction of the recording medium 16 by sequentially driving the nozzles 51-11, 51-12, . . . , 51-16 in accordance with the conveyance velocity of the recording medium 16.

On the other hand, “sub-scanning” is defined as to repeatedly perform printing of one line (a line formed of a row of dots, or a line formed of a plurality of rows of dots) formed by the main scanning, while the full-line head and the recording paper are moved relatively to each other.

The direction along one line (or the lengthwise direction of a band-shaped region) recorded by the main scanning as described above is called the “main scanning direction”, and the direction in which the sub-scanning is performed, is called the “sub-scanning direction”. In other words, in the present embodiment, the conveyance direction of the recording medium 16 is called the sub-scanning direction and the direction perpendicular to same is called the main scanning direction.

In implementing the present invention, the arrangement of the nozzles is not limited to that of the embodiment illustrated. Although a method is employed in the present embodiment where an ink droplet is ejected by means of the deformation of the actuator 58 typified by a piezoelectric element, the method used for discharging ink is not limited in particular in implementing the present invention. Instead of the piezo jet method, it is also possible to apply various types of methods, such as a thermal jet method where the ink is heated and bubbles are caused to form therein by means of a heat generating body including a heater, ink droplets being ejected by means of the pressure applied by these bubbles.

Although not shown here, the structure of the treatment liquid head 11 is approximately the same as the print head 50 described above. Since it is sufficient that the treatment liquid is applied to the recording medium 16 in a substantially uniform (even) fashion in the region where ink droplets are to be deposited, it is not necessary to form dots to a high density in comparison with the ink. Consequently, the treatment liquid head 11 may have a reduced number of nozzles (a reduced nozzle density) in comparison with the print head 50 for ejecting ink. Furthermore, a composition may also be adopted in which the nozzle diameter of the treatment liquid head 11 is greater than the nozzle diameter of the print head 50 for ejecting ink.

### Configuration of Ink Supply System

FIG. 6 is a schematic drawing showing the configuration of the ink supply system in the inkjet recording apparatus 10. The ink tank 60 is a base tank that supplies ink to the print head 50 and is set in the ink storing and loading unit 14 described with reference to FIG. 1. In other words, the ink supply tank 60 in FIG. 6 is equivalent to the ink storing and loading unit 14 in FIG. 1. The types of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type depending on the intended application, the cartridge type is suitable, and it is preferable to represent the ink type information with a bar code or the like on the cartridge, and to perform ejection control depending on the ink type.

A filter 62 for removing foreign matters and bubbles is disposed between the ink tank 60 and the print head 50 as shown in FIG. 6. The filter mesh size in the filter 62 is preferably equivalent to or less than the diameter of the nozzle. Although not shown in FIG. 6, it is preferable to provide a sub-tank integrally to the print head 50 or nearby the print head 50. The sub-tank has a damper function for preventing variation in the internal pressure of the head and a function for improving refilling of the print head.

The inkjet recording apparatus 10 is also provided with a cap 64 as a device to prevent the nozzles 51 from drying out or to prevent an increase in the ink viscosity in the vicinity of the nozzles 51, and a cleaning blade 66 as a device to clean the nozzle face 50A. A maintenance unit (restoring device) including the cap 64 and the cleaning blade 66 can be relatively moved with respect to the print head 50 by a movement mechanism (not shown), and is moved from a predetermined holding position to a maintenance position below the print head 50 as required.

The cap 64 is displaced up and down relatively with respect to the print head 50 by an elevator mechanism (not shown). When the power of the inkjet recording apparatus 10 is turned OFF or when in a print standby state, the cap 64 is raised to a predetermined elevated position so as to come into close contact with the print head 50, and the nozzle face 50A is thereby covered with the cap 64.

The cleaning blade 66 is composed of rubber or another elastic member, and can slide on the nozzle surface 50A (surface of the nozzle plate) of the print head 50 by means of a blade movement mechanism (not shown). When ink droplets or foreign matter has adhered to the surface of the nozzle plate, the surface of the nozzle plate is wiped by sliding the cleaning blade 66 on the nozzle plate.

During printing or standby, when the frequency of use of specific nozzles is reduced and ink viscosity increases in the vicinity of the nozzles, a preliminary discharge is made to eject the degraded ink toward the cap 64 (also used as an ink receptor).

When a state in which ink is not ejected from the print head 50 continues for a certain amount of time or longer, the ink solvent in the vicinity of the nozzles 51 evaporates and ink viscosity increases. In such a state, ink can no longer be ejected from the nozzle 51 even if the actuator 58 for the ejection driving is operated. Before reaching such a state (i.e., during a state that the viscosity range of the ink allows the ink ejection by the operation of the actuator 58) the actuator 58 is operated to perform the preliminary discharge to eject the ink of which viscosity has increased in the vicinity of the nozzle toward the ink receptor. After the nozzle surface is cleaned by a wiper such as the cleaning blade 66 provided as the cleaning device for the nozzle face 50A, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

On the other hand, if air bubbles become intermixed into the nozzle 51 or pressure chamber 52, or if the rise in the viscosity of the ink inside the nozzle 51 exceeds a certain level, then it may not be possible to eject ink in the preliminary ejection operation described above. In cases of this kind, the cap 64 forming a suction device is pressed against the nozzle surface 50A of the print head 50, and the ink inside the pressure chambers 52 (namely, the ink containing air bubbles or the ink of increased viscosity) is suctioned by a suction pump 67. The ink suctioned and removed by means of this suction operation is sent to a recovery tank 68. The ink collected in the recovery tank 68 may be used, or may be discarded if it is impossible to reuse that.

Since the suctioning operation is performed with respect to all of the ink in the pressure chambers 52, it consumes a large amount of ink. Therefore, desirably, preliminary ejection is carried out while the increase in the viscosity of the ink is still minor. The suction operation is also carried out when ink is loaded into the print head 50 for the first time, and when the head starts to be used after being idle for a long period of time.

The supply system for the treatment liquid is not shown; however it is substantially the same as the composition of the ink supply system shown in FIG. 6.

### Description of Control System

FIG. 7 is a principal block diagram showing the system configuration of the inkjet recording apparatus 10. The inkjet recording apparatus 10 comprises a communication interface 70, a system controller 72, an image memory 74, a ROM 75, a motor driver 76, a heater driver 78, a solvent absorbing roller drive unit 79, a print controller 80, an image buffer memory 82, a treatment liquid head driver 83, an ink head driver 84, and the like.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used as the image memory.

The system controller 72 is constituted by a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 72 controls the various sections, such as the communication interface 70, image memory 74, motor driver 76, heater driver 78, and the like. The system controller 72 controls communications with the host computer 86, controls writing and reading to and from the image memory 74, and also generates control signals for controlling the motor 88 and heater 89 of the conveyance system.

The program executed by the CPU of the system controller 72 and the various types of data that are required for control procedures are stored in the ROM 75. The ROM 75 may be a non-writeable storage device, or it may be a rewriteable storage device, such as an EEPROM. The image memory 74 is used as a temporary storage region for the image data, and it is also used as a program development region and a calculation work region for the CPU.

The motor driver (drive circuit) 76 drives the motor 88 in accordance with commands from the system controller 72. The heater driver (drive circuit) 78 drives the heater 89 of the drying unit and the heating unit 17, and the like, in accordance with commands from the system controller 72.

The print controller 80 has a signal processing function for performing various tasks, compensations, and other types of processing for generating print control signals on the basis of the image data stored in the image memory 74 in accordance with commands from the system controller 72 so as to supply the generated print data (dot data) to the treatment liquid head driver 83 and the ink head driver 84.

The image buffer memory 82 is provided in the print controller, and image data, parameters, and other data are temporarily stored in the image buffer memory 82 when image data is processed in the print controller 80. In FIG. 7, the image buffer memory 82 is depicted as being attached to the print controller 80; however, the image memory 74 may also serve as the image buffer memory 82. Also possible is a mode in which the print controller 80 and the system controller 72 are integrated to form a single processor.

To give a general description of the sequence of processing from image input to print output, image data to be printed (original image data) is input from an external source via a communication interface 70, and is accumulated in the image memory 74. At this stage, RGB image data is stored in the image memory 74, for example.

In this inkjet recording apparatus 10, an image that appears to have a continuous tonal graduation to the human eye is formed by changing the dot density and the dot size of fine dots created by depositing droplets of the ink (coloring material). Therefore, it is necessary to convert the input digital image into a dot pattern that reproduces the tonal gradations of the image (namely, the light and shade toning of the image) as faithfully as possible. Hence, original image data (RGB data) stored in the image memory 74 is sent to the print controller 80 through the system controller 72, and is converted to the dot data for each ink color by a half-toning technique, such as dithering or error diffusion, in the print controller 80.

In other words, the print controller 80 performs processing for converting the input RGB image data into dot data for the four colors of K, C, M, and Y. Furthermore, the print controller 80 determines the droplet ejection region of the treatment liquid (the region of the recording surface where ejection of treatment liquid is required) on the basis of the dot data of the respective colors, and thus generates dot data for the ejection of treatment liquid droplets. The dot data (for the treatment liquid and the respective colors) generated by the print controller 80 is stored in the image buffer memory 82.

The treatment liquid head driver 83 generates drive control signals for the treatment liquid head 11 on the basis of the dot data for treatment liquid droplet ejection stored in the image buffer memory 82. By supplying the drive control signals generated by the treatment liquid head driver 83 to the treatment liquid head 11, treatment liquid is ejected from the treatment liquid head 11.

Similarly, the ink head driver 84 generates drive control signals for the print head 50 on the basis of the dot data for ink droplet ejection stored in the image buffer memory 82. By supplying the drive control signals generated by the ink head driver 84 to the print head 50, ink is ejected from the print head 50. The treatment liquid head driver 83 and the ink head driver 84 may also each comprise feedback control systems for maintaining uniform drive conditions about the head.

By controlling the ejection of treatment liquid from the treatment liquid head 11 and the ejection of ink from the print head 50 in accordance with the conveyance speed of the recording medium 16, an image is formed on the recording medium 16.

As described above, the ejection volume and the ejection timing of the ink droplets from each nozzle are controlled via the treatment liquid head driver 83 and the ink head driver 84, on the basis of the dot data generated by implementing required signal processing in the print controller 80. By this means, desired dot size and dot arrangement can be achieved.

The inkjet recording apparatus 10 according to this embodiment further includes an ink information reading unit 90, a treatment liquid information reading unit 92, and a medium type determination unit 94. The ink information reading unit 90 is a device for reading in information relating to the ink type. More specifically, it is possible to use, for example, a device which reads in ink identification information or ink properties information from the shape of a cartridge in the ink tank 60 (see FIG. 6) (a specific shape which allows the ink type to be identified), or from a bar code or IC chip incorporated into the cartridge. Besides those, it is also possible that an operator inputs the required information through a user interface.

Similarly, the treatment liquid information reading unit 92 is a device for acquiring information relating to the type of treatment liquid. More specifically, it is possible to use, for example, a device which reads in identification information or properties information relating to the treatment liquid from the shape of the cartridge in the treatment liquid tank (a specific shape which allows the liquid type to be identified), or from a bar code or IC chip incorporated into the cartridge. Besides those, it is also possible that an operator inputs the required information through a user interface.

The medium type determination unit 94 is a device for determining the type and size of the recording medium. This section uses, for example, a device for reading in information (identification information or medium type information) from a bar code attached to the magazine 19 in the medium supply unit 18, or a sensor disposed at a suitable position in the paper conveyance path (such as a medium width determination sensor, a sensor for determining the thickness of the medium, and a sensor for determining the reflectivity of the medium). A suitable combination of these elements may also be used. Furthermore, it is also possible to adopt a composition in which information relating to the paper type, size, or the like, is specified on the basis of inputs made via a prescribed user interface, instead of or in conjunction with such automatic determination devices.

The information acquired from the various devices including the ink information reading unit 90, the treatment liquid information reading unit 92, and the medium type determination unit 94 is sent to the system controller 72, where it is used to control ejection of the treatment liquid and the ink (to control the ejection volume and ejection timing), in such a manner that suitable droplet ejection is performed in accordance with the conditions. More specifically, the system controller 72 determines the permeation speed characteristics of the recording medium 16 on the basis of the information obtained from the respective devices including the ink information reading unit 90, the treatment liquid information reading unit 92, and the medium type determination unit 94. The system controller 72 also determines whether to use a treatment liquid or not, and controls the volume to be ejected if the treatment liquid is to be used.

For example, the inkjet recording apparatus 10 comprises an information storage device (for instance, the ROM 75 shown in FIG. 7, or an internal memory or external memory (not shown)) which stores data for a media type table that associates the media types with the permeation speed characteristics. The system controller 72 determines the permeation speed characteristics of the recording medium 16 used, by referring to this media type table.

As a device for ascertaining the permeation speed characteristics of the recording medium 16, it is possible to obtain the ID (identification information) of the medium from the medium type determination unit 94, and then ascertain the permeation speed characteristics of the media by referring to the media type table. Alternatively, it is possible to record information indicating the permeation speed characteristics of the medium on an information recording body, such as a barcode attached to a magazine, and to then read in the information relating to the permeation speed characteristics of the medium directly from the medium type determination unit 94.

Alternatively, it is also possible to use a device that actually measures the permeation speed of the recording medium 16. For example, ink, treatment liquid, or both ink and treatment liquid are ejected onto the recording medium 16, the state of the dots formed by this test droplet ejection is read in by a determination device (not shown) such as an imaging element, and the permeation speed can be calculated on the basis of the information thus obtained.

As shown in FIG. 1, in the inkjet recording apparatus 10 according to the present embodiment, a composition is adopted in which the treatment liquid head 11 is disposed in an upstream position with respect to the print unit 12, and before ejecting droplets of the ink from the print unit 12, the treatment liquid is previously applied to the print surface of the recording medium 16 by the preceding (upstream) treatment liquid head 11, in a single operation. In the case of this composition, the amount of the treatment liquid on the recording medium 16 gradually declines as the volume of the ink droplets deposited by the print unit 12 increases. Therefore, the further the position toward the downstream side of the print unit 12, the smaller the amount of the treatment liquid remaining on the recording medium 16. It is necessary that some treatment liquid remains on the surface of the recording medium 16 and/or in the vicinity thereof, until droplet ejection by the print head in the final stage (furthest downstream position) of the print unit 12 (in FIG. 1, the yellow head 12Y) has been completed. Therefore, the amount of treatment liquid ejected by the treatment liquid head 11 is determined on the basis of the type of recording medium 16, the properties of the treatment liquid, the ejected ink volume, the conveyance speed of the recording medium 16, and the like, in such a manner that presence of the required amount of treatment liquid can be ensured.

Furthermore, the system controller 72 shown in FIG. 7 controls a solvent absorbing roller drive unit 79 depending on the thickness and permeation speed characteristics of the recording medium 16, and the like, thereby suitably controlling the vertical positioning of the solvent absorbing roller 15 (the contact pressure on the recording medium 16 and/or the clearance with respect to the recording medium 16) and the rotational speed. The solvent absorbing roller drive unit 79 is a device for adjusting the position and rotational speed of the solvent absorbing roller 15 with respect to the recording surface of the recording medium 16. The solvent absorbing roller drive unit 79 comprises an elevator mechanism for moving the solvent absorbing roller 15 upward and downward, an electric motor (actuator) forming a drive source for moving this mechanism and its driver, a drive transmission mechanism (belt, pulley or gear, or a suitable combination of same) which transmits the driving force of the motor to the elevator mechanism, a motor forming a driving source for causing the solvent absorbing roller 15 to rotate and its driver, drive transmission mechanism for same, the heater driver for the heating unit 17 for heating and drying the aggregate generated on the recording medium 16, and the like.

### Description of Image Forming Process

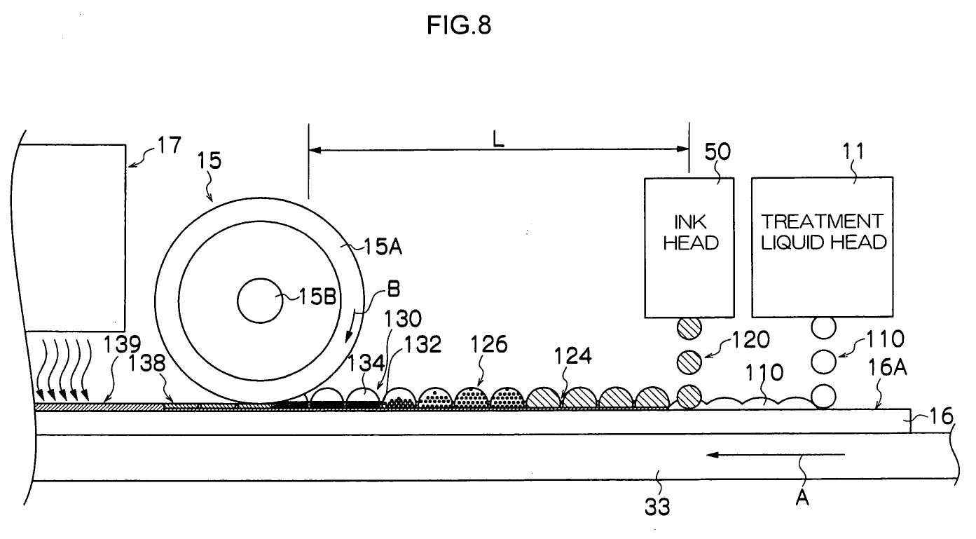

Next, an image forming process in the inkjet recording apparatus 10 according to the present embodiment is described below. FIG. 8 is an enlarged diagram showing a schematic representation of the principal composition at the periphery of the print unit 12 of the inkjet recording apparatus 10. In FIG. 8, in order to simplify the drawings, only one ink head (print head 50) is shown after the treatment liquid head 11; however, the actual print unit 12 is provided with the four print heads 12K, 12C, 12M, and 12Y, for the four respective colors, as shown in FIG. 1.

In FIG. 8, the recording medium 16 is conveyed from right to left. The image forming process is as described below.

### (Step 1)

Treatment liquid 110 is ejected in the form of droplets from the treatment liquid head 11 disposed on the upstream side in terms of the recording medium conveyance direction (the direction of arrow A in FIG. 8), thereby the treatment liquid 110 being applied to the recording surface 16A of the recording medium 16 in advance.

### (Step 2)

Ink 120 is ejected in the form of droplets from the print head 50 disposed on the downstream side with respect to the treatment liquid head 11 (i.e., after the treatment liquid head 11). The volume of each of the ejected droplets of the ink 120 is not less than 0.5 pl and not more than 2.5 pl. The ink 120 is thus applied to the recording surface 16A of the recording medium 16 on which the treatment liquid 110 exists.

### (Step 3)

The ink 120 is mixed with the treatment liquid 110 on the surface of the recording medium 16, and consequently, the anionic group in the low-molecular dispersant which has been dispersed in the ink 120 together with the coloring material undergoes a pH change by coming into contact with the treatment liquid 110, thus producing an aggregation reaction. A coloring material aggregate 126 is generated by the aggregation of the coloring material in the ink 120.

### (Step 4)

As shown in FIG. 8, the coloring material aggregate 126 sinks downward to the recording medium 16 side. In this way, the liquid droplets (dots) 130 of the ink 120 on the recording medium 16 are separated into a coloring material layer 132 including the coloring material aggregate 126 which has sunk, and a layer of solvent 134.

### (Step 5)

With the conveyance of the recording medium 16 (the conveyance in the direction of arrow A in FIG. 8), the liquid droplet 130 that has been separated into the coloring material layer 132 and the solvent 134 is moved to the position of the solvent absorbing roller 15. When the solvent 134 in the liquid droplet 130 comes into contact with the solvent absorbing roller 15, then the solvent 134 is absorbed into the solvent absorbing roller 15 by the capillary force of the porous member 15A. The solvent absorbing roller 15 is rotated in the direction of arrow B in FIG. 8 in accordance with the conveyance speed of the recording medium 16, in such a manner that the relative speed of the roller with respect to the recording medium 16 is zero, thereby preventing disturbance of the image due to rubbing of the ink. Furthermore, in this case, since the polymer film 124 is formed around the periphery of the dots 130, then the movement of the coloring material on the surface of the recording medium 16 is suppressed, and adherence of the coloring material to the solvent absorbing roller 15 is prevented, thereby avoiding disturbance of the image, and the like. More specifically, when the solvent is absorbed by the solvent absorbing roller 15, the film 124 is present between the dots. Hence, this film 124 has the role of suppressing the movement of the ink and preventing disturbance of the image during contact between the solvent absorbing roller 15 and the ink.

The positional relationship between the print head 50 and the solvent absorbing roller 15 (the distance L from the position of the ink landing on the recording medium to the position of the solvent contacting with the roller), and the conveyance speed of the recording medium 16, are set in such a manner that the time period from the landing time of the ink 120 ejected from the print head 50 (in other words, from the mixing time of the two liquids) until the contact time between the solvent 134 and the solvent absorbing roller 15 is longer than the time period taken from the landing time of the ink 120 until the completion time of separation between the coloring material and solvent due to the two-liquid reaction.

### (Step 6)

In the ink from which the solvent has been removed by the solvent absorbing roller 15 in this way (reference numeral 138 in FIG. 8), the coupling force between the coloring material bodies increases, and the coloring material becomes fixed onto the recording medium 16. Thereby, the occurrence of bleeding is prevented, and furthermore, beneficial effects are obtained in that bleeding between colors is prevented, drying and fixing are promoted, and cockling is avoided, and the like.

### (Step 7)

Subsequently, a hot airflow heated to a temperature of approximately 30° C. by the heating unit 17 is directed to the recording medium 16, thereby causing the solvent component contained in the coloring material aggregate 126 to evaporate and dry. Furthermore, the polymer micro-particles dispersed with the coloring material dry and harden to form a film, whereby the coloring material becomes fixed reliably on the recording medium 16 (reference numeral 139). Moreover, since the polymer micro-particles are hydrophobic, then the water resistance is also improved. Consequently, a print having excellent rubbing resistance, water resistance and fixing properties is obtained.

### WORKING EXAMPLES

Next, the present invention is described in detail by means of working examples, but the present invention is not limited to these examples. In the following description, the symbol “%” refers to the “weight percentage”, unless stated otherwise.

### Working Example 1

### 1-1 Preparation of Yellow Ink Y-1

1.0 parts of C.I. Solvent Yellow 14 were mixed with 99.0 parts of acetone and agitated while heating at 40° C., to achieve a uniform solution. This mixed solution was then added to and mixed with a solution formed by dissolving 1.0 parts of the below-described polymer dispersant BP-1 having an average molecular weight of 35000, in 99.0 parts of tetrahydrofuran. Thereupon, 10.0 parts of water were added. Subsequently, the acetone and the tetrahydrofuran were removed completely in a rotary evaporator, to yield a coloring material dispersion of C.I. Solvent Yellow 14.

400 g of the coloring material dispersion of C.I. Solvent Yellow 14, 150 g of tripropylene glycol, 50 g of triethylene glycol, 50 g of 1% tris-hydroxyaminomethane-hydrochloric acid buffer, and 10 g of Olefin E1010 manufactured by Nisshin Kagaku Kogyo, were mixed into 340 g of deionized water and agitated, to yield yellow ink Y-1. The volume-average particle size of the coloring material in the ink thus obtained was 55 nm when measured with a Nikkiso Microtrac UPA EX150. The polymer dispersant BP-1 is an AB-type block polymer including 2-decanoxyethyl vinyl ether-Block-(4-(2-vinyl oxyethoxy) benzoic acid), and it can be synthesized by the same method as that described in Japanese Patent Application Publication No. 2004-210940.

### 1-2 Image Quality Evaluation 1

Printing was carried out on Tokubishi art both surfaces N manufactured by Mitsubishi Paper Mills Ltd., at a printing ratio of 80%, by depositing a treatment liquid (a liquid combining 89 ml of 0.3 mol/L hydrochloric acid, 10 ml of glycerine, and 1 g of olefin E1010) capable of converting the ink to a gel, and then depositing the ink Y-1, using the following commercially available inkjet recording printers as the inkjet recording apparatus: a BJF-850 (product name, manufactured by Canon, droplet volume: 4 pl), a PX-V630 (product name, manufactured by Seiko Epson, droplet volume: 3 pl), and a PX-G920 (product name, manufactured by Seiko Epson, droplet volume: 1.5 pl, 2 pl, 2.5 pl). The droplet volume was adjusted to 2 pl and 2.5 pl in the PX-G920 by applying an appropriate drive waveform. Table 1 shows the results of the evaluation of the ink samples.

TABLE 1

| Liquid droplet | | | |
|---|---|---|---|
| size | Bleeding *1 | Pile height *2 | Comments |
| 4 pl | 100 | poor | Comparative Example |
| 3 pl | 97 | average | Comparative Example |
| 2.5 pl | 97 | good | Practical Example |
| 2 pl | 95 | good | Practical Example |
| 1.5 pl | 95 | good | Practical Example |

*1: Bleeding: Spreading ratio = dot diameter of liquid droplet calculated from printed dot diameter/liquid droplet size; a relative value, where the spreading rate at a droplet volume of 4 pl is normalized to a value of 100. The smaller the value, the better the result.
*2: Pile height:
good: No undulations observed in ink upon visual inspection.
average: Slight undulations observed in ink upon visual inspection.
poor: Clear undulations observed in ink upon visual inspection.

As shown above, it was possible to observe undulations in the dots when the liquid droplet size was 3 pl, but no undulations were observed when the droplet size was 1.5 pl. It can be seen that the pile height is reduced if droplets are ejected at the liquid droplet size according to the present invention.

### Working Example 2

### 2-1 Preparation of Magenta Ink M-1

A magenta ink M-1 was obtained by exactly the same method as above, except that the C.I. Solvent Yellow 14 was substituted with C.I. Solvent Red 27. The volume-average particle size of the coloring material in the ink thus obtained was 45 nm.

### 2-2 Evaluation of Image Quality

Table 2 shows the results of an image quality evaluation using the same method as working example 1. Similarly to the results according to working example 1, it can be seen that the pile height is reduced when droplets are ejected at the liquid droplet size according to the present invention.

TABLE 2

| Liquid droplet | | | |
|---|---|---|---|
| size | Bleeding *1 | Pile height *2 | Comments |
| 4 pl | 100 | poor | Comparative Example |
| 3 pl | 101 | average | Comparative Example |
| 2.5 pl | 100 | good | Practical Example |
| 2 pl | 100 | good | Practical Example |
| 1.5 pl | 98 | good | Practical Example |

### Working Example 3

### 3-1 Preparation of Cyan Ink C-1

1.0 g of C.I. Solvent Red 44 was mixed with 99.0 g of acetone and agitated while heating at 40° C., to achieve a uniform solution. This mixed solution was then added to and mixed with a solution formed by dissolving 1.0 g of the polymer dispersant BP-1 in 99.0 g of tetrahydrofuran. Thereupon, 10.0 g of water was added. Subsequently, the acetone and the tetrahydrofuran were removed completely in a rotary evaporator, to yield a coloring material dispersion. 50.0 g of the coloring material dispersion thus obtained, 10.0 g of diethylene glycol, 10.0 g of thio diglycol, and 1 g of Olefin E1010 manufactured by Nisshin Kagaku Kogyo, were mixed with 29.0 g of deionized water and agitated sufficiently, thereby yielding cyan ink C-1. The volume-average particle size of the coloring material in the ink thus obtained was 50 nm.

### 3-2 Evaluation of Image Quality

Table 3 shows the results of an image quality evaluation using the same method as working example 1. Similarly to the results according to working example 1, it can be seen that the pile height is reduced when droplets are ejected at the liquid droplet size according to the present invention.

TABLE 3

| Liquid droplet | | | |
|---|---|---|---|
| size | Bleeding *1 | Pile height *2 | Comments |
| 4 pl | 100 | poor | Comparative Example |
| 3 pl | 98 | average | Comparative Example |
| 2.5 pl | 98 | good | Practical Example |
| 2 pl | 98 | good | Practical Example |
| 1.5 pl | 97 | good | Practical Example |

### Practical Example 4

### 4-1 Cyan Ink C-2

A cyan ink C-2 was prepared using exactly the same method as that used to prepare the cyan ink C-1 described above, except that the C.I. Solvent Blue 44 was substituted with C.I. Pigment Blue 15:3. The volume-average particle size of the coloring material in the ink thus obtained was 60 nm.

### 4-2 Evaluation of Image Quality

When the image quality was evaluated by the same method as that of working example 1, similar tendencies to those of working example 1 were observed with respect to bleeding and the pile height.

### Working Example 5

### 5-1 Magenta Ink M-2

At first, 1 parts of C.I. Pigment Red 122 (product name: CROMOPHTAL Jet Magenta DMQ, manufactured by Ciba Specialty Chemicals Ltd.) were mixed with 99 parts of acetone and agitated while heating at 40° C., to obtain a uniform solution. This mixed solution was then added to and mixed with a solution formed by dissolving 1 parts of polymer dispersant BP-1 in 99 parts of acetone. Thereupon, 10.0 parts of water were added. Subsequently, the acetone was removed in a rotary evaporator, thereby yielding a coloring material dispersant. This coloring material dispersant was dispersed by means of a beads mill, and then mixed with 2 parts of diethylene glycol, 2 parts of glycerine, 1 parts of triethanol amine, 0.5 parts of olefin E1010 (manufactured by Nisshin Kagaku Kogyo), 1 part of triethylene glycol monobutyl ether, and deionized water sufficient to achieve a total volume of 50 parts, thereby yielding a magenta ink C-2. The volume-average particle size of the coloring material in the ink thus obtained was 75 nm.

### 5-2 Evaluation of Image Quality

When the image quality was evaluated by the same method as that of working example 1, similar tendencies to those of working example 1 were observed with respect to bleeding and the pile height.

From the results of the working examples 1 to 5 described above, by making the ejection droplet size 3 pl or less, image degradation caused by the large pile height which is based on ink that converts from a sol to a gel as a result of a stimulus, ceases to be observable, and hence it can be seen that enormously beneficial results are obtained in improving image quality.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image recording method for forming an image on a recording medium, including the step of applying droplets of stimulus-responsive ink which responds to a stimulus so that the stimulus-responsive ink converts from a sol state to a gel state, on the recording medium,
wherein each of the droplets of the stimulus-responsive ink has a volume of 0.5 pl to 2.5 pl.

2. The image recording method as defined in claim 1, wherein each of the droplets of the stimulus-responsive ink has a volume of 0.5 pl to 1.5 pl.

3. The image recording method as defined in claim 1, further comprising the step of applying a treatment liquid on the recording medium, wherein:
the treatment liquid comes into contact with the droplets of the stimulus-responsive ink in a droplet ejection region of the recording medium where the droplets of the stimulus-responsive ink are applied; and
the stimulus to which the stimulus-responsive ink responds is a chemical stimulus caused by the treatment liquid.

4. The image recording method as defined in claim 3, wherein the chemical stimulus is based on a pH change.

5. The image recording method as defined in claim 3, further comprising the step of applying a liquid composition which does not contain coloring material and responds to a stimulus caused by the treatment liquid so that the liquid composition converts from a sol state to a gel state, on the recording medium,
wherein the liquid composition comes into contact with the treatment liquid in a non-droplet ejection region of the recording medium where the droplets of the stimulus-responsive ink are not applied.

6. The image recording method as defined in claim 1, wherein:
the stimulus-responsive ink contains at least a water-insoluble coloring material, a water-soluble organic solvent, a polymer dispersant, and water; and
the polymer dispersant contains a block copolymer having at least one type of hydrophobic block and at least one type of hydrophilic block.

7. The image recording method as defined in claim 5, wherein the liquid composition contains ingredients which are same as all ingredients except for a water-insoluble coloring material contained in the stimulus-responsive ink.

8. The image recording method as defined in claim 6, wherein the water-insoluble coloring material contains at least one material selected from the group consisting of C.I. Solvent Yellow 21, C.I. Solvent Yellow 42, C.I. Solvent Yellow 79, C.I. Solvent Yellow 82, C.I. Solvent Yellow 83:1, C.I. Solvent Yellow 88, and C.I. Solvent Yellow 151.

9. The image recording method as defined in claim 6, wherein the water-insoluble coloring material contains at least one material selected from the group consisting of C.I. Solvent Red 8, C.I. Solvent Red 49, C.I. Solvent Red 83:1, C.I. Solvent Red 91, C.I. Solvent Red 127 and C.I. Solvent Red 218.

10. The image recording method as defined in claim 6, wherein the water-insoluble coloring material contains at least one material selected from the group consisting of C.I. Solvent Blue 25, C.I. Solvent Blue 38, C.I. Solvent Blue 44, C.I. Solvent Blue 67, and C.I. Solvent Blue 70.

11. The image recording method as defined in claim 6, wherein the water-insoluble coloring material contains at least one material selected from the group consisting of C.I. Solvent Black 3, C.I. Solvent Black 27, C.I. Solvent Black 29 and C.I. Solvent Black 45.

12. The image recording method as defined in claim 6, wherein the water-insoluble coloring material contains at least one material selected from the group consisting of C.I. Pigment Yellow 3, C.I. Pigment Yellow 74, C.I. Pigment Yellow 93, C.I. Pigment Yellow 95, C.I. Pigment Yellow 109, C.I. Pigment Yellow 120, C.I. Pigment Yellow 128, C.I. Pigment Yellow 138, C.I. Pigment Yellow 150, C.I. Pigment Yellow 151, C.I. Pigment Yellow 155, C.I. Pigment Yellow 175, C.I. Pigment Yellow 183, C.I. Pigment Yellow 184, C.I. Pigment Violet 19, C.I. Pigment Violet 23, C.I. Pigment Red 122, C.I. Pigment Red 254, C.I. Pigment Green 36 and C.I. Pigment Blue 15:3.

13. The image recording method as defined in claim 1, wherein the stimulus-responsive ink contains a water-insoluble coloring material having a particle size of not greater than 80 nm.

14. The image recording method as defined in claim 1, wherein the droplets of the stimulus-responsive ink are applied on the recording medium by transferring the droplets of the stimulus-responsive ink from an intermediate body to the recording medium.

15. An image recording apparatus which forms an image by means of the image recording method as defined in claim 1.
